(19) United States
(12) Patent Application Publication
(10) Pub. No.: US 2017/0342215 A1
(43) Pub. Date: Nov. 30, 2017

(54) POLYIMIDE FILM, POLYIMIDE PRECURSOR, AND POLYIMIDE

(71) Applicant: UBE INDUSTRIES, LTD., Ube-shi, Yamaguchi (JP)

(72) Inventors: Takuya OKA, Ube-shi, Yamaguchi (JP); Yukinori KOHAMA, Ube-shi, Yamaguchi (JP); Nobuharu HISANO, Ube-shi, Yamaguchi (JP)

(21) Appl. No.: 15/520,971

(22) PCT Filed: Oct. 23, 2015
(86) PCT No.: PCT/JP2015/080040

§ 371 Date: Apr. 21, 2017

(30) Foreign Application Priority Data
Oct. 23, 2014 (JP) 2014-216715

(51) Int. Cl. C08G 73/10; C08J 5/18

(52) U.S. Cl. CPC C08G 73/1078; C08J 5/18; C08J 2479/08

(57) ABSTRACT

The present invention relates to a polyimide film consisting essentially of a polyimide comprising a repeating unit represented by the following chemical formula (1):

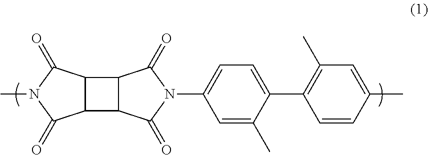

wherein the film has a YI (yellowness index) of 4 or less, a tensile modulus of elasticity of 4 GPa or more, and a load at break of 10 N or more.

### TECHNICAL FIELD

The present invention relates to a polyimide film and a polyimide which have excellent transparency and excellent mechanical properties. The present invention also relates to a polyimide precursor and a polyimide precursor composition from which a polyimide film having excellent transparency and excellent mechanical properties may be obtained.

### BACKGROUND ART

With the coming of an advanced information society, the developments of optical materials such as an optical fiber and an optical waveguide in the field of optical communications, and a liquid crystal oriented film and a protective film for a color-filter in the field of display devices have recently advanced. In the field of display devices, in particular, the study of a plastic substrate which is light-weight and excellent in flexibility as an alternative to a glass substrate, and the development of a display which is capable of being bent and rolled have been intensively conducted. In addition, a plastic cover sheet has also been studied as an alternative to a cover glass to protect a display screen. Accordingly, there is need for a higher-performance optical material which may be used for such purposes.

Aromatic polyimides are intrinsically yellowish-brown-colored due to the intramolecular conjugation and the formation of the charge-transfer complex. Accordingly, as a means of reducing coloring, methods of developing transparency, for example, by introducing a fluorine atom into the molecule, imparting flexibility to the main chain, introducing a bulky group as a side chain, or the like to suppress the intramolecular conjugation and the formation of the charge-transfer complex have been proposed.

In addition, methods of developing transparency by the use of a semi-alicyclic or wholly-alicyclic polyimide which do not form a charge-transfer complex in principle have been also proposed. Many semi-alicyclic polyimides using aromatic tetracarboxylic dianhydride as the tetracarboxylic acid component and alicyclic diamine as the diamine component and having high transparency, and many semi-alicyclic polyimides using alicyclic tetracarboxylic dianhydride as the tetracarboxylic acid component and aromatic diamine as the diamine component and having high transparency, in particular, have been proposed.

For example, Non Patent Literature 1 discloses a polyimide in which norbornane-2-spiro-α-cyclopentanone-α′-spiro-2″-norbornane-5,5″,6,6″-tetracarboxylic dianhydride is used as the tetracarboxylic acid component and an aromatic diamine is used as the diamine component. Patent Literatures 1 to 5 also disclose a polyimide in which norbornane-2-spiro-α-cyclopentanone-α′-spiro-2″-norbornane-5,5″,6,6″-tetracarboxylic dianhydride is used as the tetracarboxylic acid component and an aromatic diamine is used as the diamine component.

Patent Literature 6 discloses, as a polyimide precursor from which a polyimide film being colorless and transparent, and having a low coefficient of linear expansion and excellent elongation may be produced, a polyimide precursor which has a structure derived from 2,2′-bis(trifluoromethyl) benzidine (TFMB) as the structure derived from the diamine, and structures derived from pyromellitic dianhydride (PMDA) and 4,4′-oxydiphthalic dianhydride (ODPA) and structures derived from 1,2,3,4-cyclobutane tetracarboxylic dianhydride (CBDA) and/or 1,2,4,5-cyclohexane tetracarboxylic dianhydride (H-PMDA) as the structure derived from the acid dianhydride. Patent Literature 7 discloses a poly(amic acid-imide) copolymer polymerized from 1,2,3,4-cyclobutane tetracarboxylic dianhydride as the tetracarboxylic acid component, and 2,2′-bis(trifluoromethyl)benzidine and a specific imide group-containing diamine as the diamine component.

In some applications, however, a polyimide and a polyimide film which have excellent mechanical properties such as higher modulus of elasticity in addition to excellent transparency are required. For example, both high transparency and high modulus of elasticity are required for a cover sheet to protect a display screen. Additionally, high transparency is required for a substrate for a display, and in the case of a flexible-type display, in particular, high modulus of elasticity may also be required for the substrate in addition to high transparency.

Meanwhile, Patent Literature 8 discloses, as an imide compound useful as a component of a liquid crystal alignment agent, a polyimide in which 1,2,3,4-cyclobutane tetracarboxylic dianhydride is used as the tetracarboxylic acid component and an aromatic diamine such as 4,4′-diaminodiphenylmethane and aniline is used as the diamine component. Patent Literature 9 discloses a liquid crystal alignment agent comprising a polyimide in which 1,2,3,4-cyclobutane tetracarboxylic dianhydride is used as the tetracarboxylic acid component and 2,2′-dimethyl-4,4′-diaminobiphenyl is used as the diamine component.

Meanwhile, Patent Literature 10 discloses a liquid crystal alignment film (polyimide film) which is formed by heating a coating solution obtained by mixing a polyimide precursor (polyamic acid) with an imidazoline compound and/or an imidazole compound. More specifically, a polyimide film is obtained by applying a solution obtained by adding 2,4-dimethylimidazoline to a solution of a polyamic acid obtained from 3,3′,4,4′-benzophenone tetracarboxylic dianhydride and 4,4′-diaminodiphenyl ether (Example 1) or a solution obtained by adding 2-ethylimidazoline and 1,2-dimethylimidazole to a solution of a polyamic acid obtained from pyromellitic dianhydride and 4,4′-diaminodiphenyl ether (Example 2) on a substrate, and then heating the solution.

In addition, as a process for producing an aromatic polyimide which has low transparency, Patent Literature 11 discloses a process for forming a polyimide resin layer, comprising applying a solution containing a polyimide precursor resin, which is obtained by dissolving the polyimide precursor resin and an accelerator for the curing of the polyimide precursor resin such as imidazole and N-methylimidazole in an organic polar solvent, on a substrate, and then subjecting the solution to subsequent heat treatment in which the formation of the polyimide resin layer is completed by drying and imidization in the range of 280° C. to 380° C.

### CITATION LIST

### Patent Literature

Patent Literature 1: WO2011/099518
Patent Literature 2: WO2013/021942
Patent Literature 3: WO2014/034760
Patent Literature 4: WO2013/179727
Patent Literature 5: WO2014/046064
Patent Literature 6: JP-A-2014-139302
Patent Literature 7: JP-A-2005-336243
Patent Literature 8: JP-A-H09-71649
Patent Literature 9: JP-A-2004-109311
Patent Literature 10: JP-A-S61-267030
Patent Literature 11: JP-A-2008-115378

### Non Patent Literature

Non Patent Literature 1: KOUBUNSHI RONBUNSHU (Japanese Journal of Polymer Science and Technology), Vol. 68, No. 3, P. 127-131 (2011)

### SUMMARY OF INVENTION

### Technical Problem

The present invention was made in view of the circumstances as described above, and an object thereof is to provide a polyimide film and a polyimide which have excellent transparency and excellent mechanical properties. An object of the present invention is also to provide a polyimide precursor and a polyimide precursor composition from which a polyimide film having excellent transparency and excellent mechanical properties may be obtained.

### Solution to Problem

The present invention relates to the following items.

[1] A polyimide film consisting essentially of a polyimide comprising a repeating unit represented by the following chemical formula (1) in an amount of 50 mol % or more relative to the total repeating units, or a polyimide comprising a repeating unit represented by the following chemical formula (1) and a repeating unit represented by the following chemical formula (2) in an amount of 50 mol % or more relative to the total repeating units:

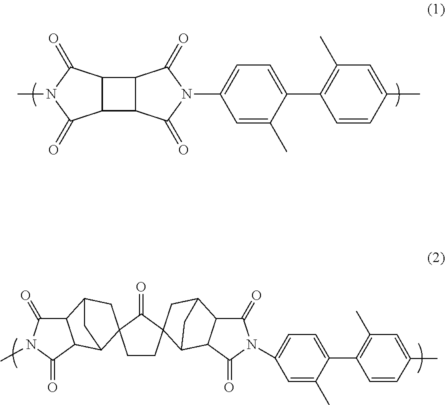

wherein the film has a YI (yellowness index) of 4 or less, a tensile modulus of elasticity of 4 GPa or more, and a load at break of 10 N or more.

[2] The polyimide film as described in [1], wherein the polyimide film has a thickness of 5 m to 200 μm.

[3] The polyimide film as described in [1] or [2], wherein the polyimide comprises a repeating unit represented by the following chemical formula (3) [including a repeating unit represented by the chemical formula (1)] in an amount of 90 mol % or more relative to the total repeating units, or comprises a repeating unit represented by the following chemical formula (3) and a repeating unit represented by the following chemical formula (4) [including a repeating unit represented by the chemical formula (1) and a repeating unit represented by the chemical formula (2)] in an amount of 90 mol % or more relative to the total repeating units:

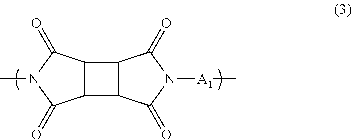

wherein A₁ is a divalent group having an aromatic ring,

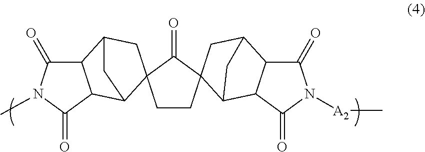

wherein A₂ is a divalent group having an aromatic ring,
and the amount of the repeating unit represented by the chemical formula (1), or the total amount of the repeating unit represented by the chemical formula (1) and the repeating unit represented by the chemical formula (2) is 50 mol % to 100 mol % relative to the total repeating units.

[4] The polyimide film as described in any one of [1] to [3], wherein the polyimide film has a haze of 3% or less.

[5] A polyimide precursor composition comprising

a polyimide precursor comprising a repeating unit represented by the following chemical formula (1A) in an amount of 50 mol % or more relative to the total repeating units, or a polyimide precursor comprising a repeating unit represented by the following chemical formula (1A) and a repeating unit represented by the following chemical formula (2A) in an amount of 50 mol % or more relative to the total repeating units:

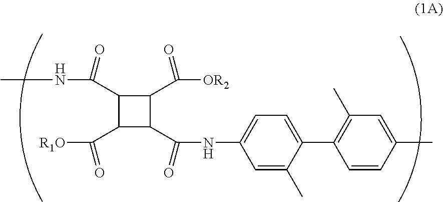

wherein R₁ and R₂ are each independently hydrogen, an alkyl group having 1 to 6 carbon atoms, or an alkylsilyl group having 3 to 9 carbon atoms,

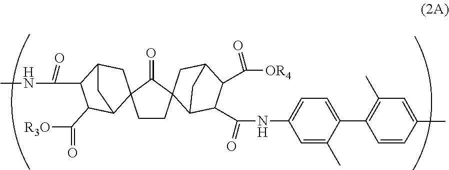

wherein R₃ and R₄ are each independently hydrogen, an alkyl group having 1 to 6 carbon atoms, or an alkylsilyl group having 3 to 9 carbon atoms,
and

an imidazole compound and/or a trialkylamine compound.

[6] The polyimide precursor composition as described in [5], wherein the polyimide precursor comprises a repeating unit represented by the following chemical formula (3A) [including a repeating unit represented by the chemical formula (1A)] in an amount of 90 mol % or more relative to the total repeating units, or comprises a repeating unit represented by the following chemical formula (3A) and a repeating unit represented by the following chemical formula (4A) [including a repeating unit represented by the chemical formula (1A) and a repeating unit represented by the chemical formula (2A)] in an amount of 90 mol % or more relative to the total repeating units:

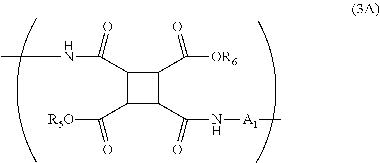

wherein A₁ is a divalent group having an aromatic ring; and R₅ and R₆ are each independently hydrogen, an alkyl group having 1 to 6 carbon atoms, or an alkylsilyl group having 3 to 9 carbon atoms,

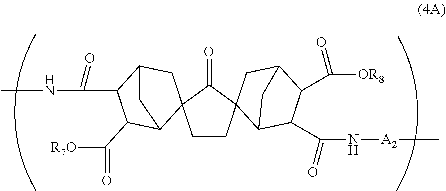

wherein A₂ is a divalent group having an aromatic ring; and R₇ and R₈ are each independently hydrogen, an alkyl group having 1 to 6 carbon atoms, or an alkylsilyl group having 3 to 9 carbon atoms, and the amount of the repeating unit represented by the chemical formula (1A), or the total amount of the repeating unit represented by the chemical formula (1A) and the repeating unit represented by the chemical formula (2A) is 50 mol % to 100 mol % relative to the total repeating units.

[7] The polyimide precursor composition as described in [5] or [6], wherein the amount of the imidazole compound and/or the trialkylamine compound in the polyimide precursor composition is less than 4 mol relative to 1 mol of the repeating unit of the polyimide precursor.

[8] The polyimide precursor composition as described in any one of [5] to [7], wherein the polyimide precursor composition comprises any one or more of 1,2-dimethylimidazole, 1-methylimidazole or imidazole as the imidazole compound, or comprises triethylamine as the trialkylamine compound.

[9] A polyimide precursor comprising a repeating unit represented by the following chemical formula (1A) and a repeating unit represented by the following chemical formula (2A) in an amount of 50 mol % or more relative to the total repeating units:

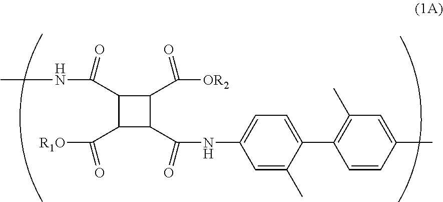

wherein R₁ and R₂ are each independently hydrogen, an alkyl group having 1 to 6 carbon atoms, or an alkylsilyl group having 3 to 9 carbon atoms,

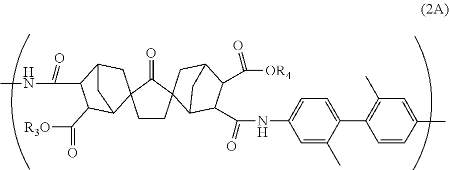

wherein R₃ and R₄ are each independently hydrogen, an alkyl group having 1 to 6 carbon atoms, or an alkylsilyl group having 3 to 9 carbon atoms.

[10] The polyimide precursor as described in [9], wherein the amount of the repeating unit represented by the chemical formula (1A) is 10 mol % to 90 mol % relative to the total repeating units, and the amount of the repeating unit represented by the chemical formula (2A) is 10 mol % to 90 mol % relative to the total repeating units.

[11] The polyimide precursor as described in [9] or [10], wherein the polyimide precursor comprises a repeating unit represented by the following chemical formula (3A) and a repeating unit represented by the following chemical formula (4A) [including a repeating unit represented by the chemical formula (1A) and a repeating unit represented by the chemical formula (2A)] in an amount of 90 mol % or more relative to the total repeating units:

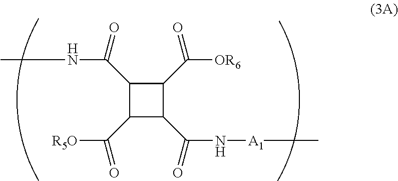

wherein A₁ is a divalent group having an aromatic ring; and R₅ and R₆ are each independently hydrogen, an alkyl group having 1 to 6 carbon atoms, or an alkylsilyl group having 3 to 9 carbon atoms,

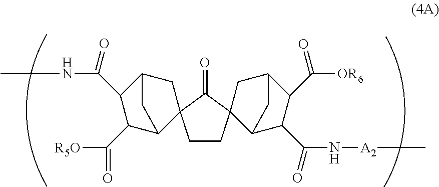

wherein A₂ is a divalent group having an aromatic ring; and R₇ and R₈ are each independently hydrogen, an alkyl group having 1 to 6 carbon atoms, or an alkylsilyl group having 3 to 9 carbon atoms,
and the total amount of the repeating unit represented by the chemical formula (1A) and the repeating unit represented by the chemical formula (2A) is 50 mol % to 100 mol % relative to the total repeating units.

[12] A polyimide precursor composition comprising the polyimide precursor as described in any one of [9] to [11].

[13] A polyimide comprising a repeating unit represented by the following chemical formula (1) in an amount of 50 mol % or more relative to the total repeating units, or a polyimide comprising a repeating unit represented by the following chemical formula (1) and a repeating unit represented by the following chemical formula (2) in an amount of 50 mol % or more relative to the total repeating units:

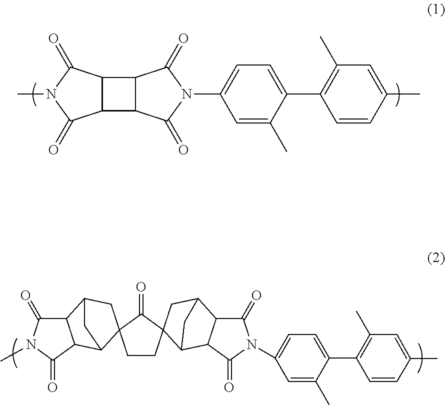

wherein the polyimide is obtained by heating a polyimide precursor composition comprising a precursor of the polyimide, and an imidazole compound and/or a trialkylamine compound.

[14] A polyimide obtained from the polyimide precursor composition as described in any one of [5] to [8].

[15] A polyimide comprising a repeating unit represented by the following chemical formula (1) and a repeating unit represented by the following chemical formula (2) in an amount of 50 mol % or more relative to the total repeating units:

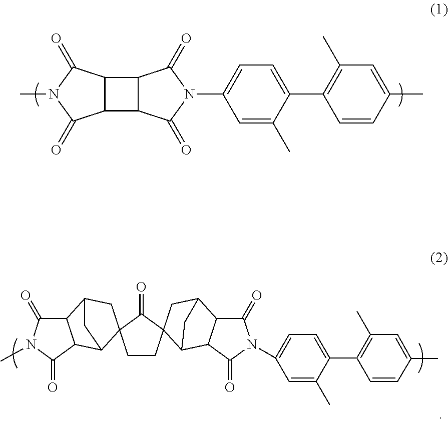

[16] A polyimide obtained from the polyimide precursor as described in any one of [9] to [11], or the polyimide precursor composition as described in [12].

[17] A polyimide film obtained from the polyimide precursor composition as described in any one of [5] to [8], or a polyimide precursor composition comprising the polyimide precursor as described in any one of [9] to [11].

[18] A film consisting essentially of the polyimide as described in any one of [13] to [16].

[19] A cover sheet for a display screen, comprising the polyimide film as described in any one of [1] to [4], [17] or [18], or the polyimide as described in any one of [13] to [16].

[20] A substrate for a display, a touch panel or a solar battery, comprising the polyimide film as described in any one of [1] to [4], [17] or [18], or the polyimide as described in any one of [13] to [16].

The chemical formula (1A) and the chemical formula (3A) indicate that in a cyclobutane ring, the acid group in either 3-position or 4-position reacts with an amino group to form an amide bond (—CONH—) and the other is a group represented by the formula: —COOR₂ or —COOR₆, which does not form an amide bond, on the assumption that the acid group in 1-position reacts with an amino group to form an amide bond (—CONH—) and the acid group in 2-position is a group represented by the formula: —COOR₁ or —COOR₅, which does not form an amide bond. In other words, the chemical formula (1A) and the chemical formula (3A) include the two structural isomers.

The chemical formula (2A) and the chemical formula (4A) indicate that in two norbornane rings (bicyclo[2.2.1]heptane), the acid group in either 5-position or 6-position reacts with an amino group to form an amide bond (—CONH—) and the other is a group represented by the formula: —COOR₃ or —COOR₇, or a group represented by the formula: —COOR₄ or —COOR₈, both of which do not form an amide bond. In other words, the chemical formula (2A) and the chemical formula (4A) include all of the four structural isomers, that is,

(i) the one having a group represented by the formula: —COOR₃ or —COOR₇ in the 5-position and a group represented by the formula: —CONH— in the 6-position, and having a group represented by the formula: —COOR₄ or —COOR₈ in the 5″-position and a group represented by the formula: —CONH-A₂ (or a group represented by the chemical formula (D-1))—in the 6″-position;

(ii) the one having a group represented by the formula: —COOR₃ or —COOR₇ in the 6-position and a group represented by the formula: —CONH— in the 5-position, and having a group represented by the formula: —COOR₄ or —COOR₈ in the 5″-position and a group represented by the formula: —CONH-A₂ (or a group represented by the chemical formula (D-1))—in the 6″-position;

(iii) the one having a group represented by the formula: —COOR₃ or —COOR₇ in the 5-position and a group represented by the formula: —CONH— in the 6-position, and having a group represented by the formula: —COOR₄ or —COOR₈ in the 6″-position and a group represented by the formula: —CONH-A₂ (or a group represented by the chemical formula (D-1))—in the 5″-position; and

(iv) the one having a group represented by the formula: —COOR₃ or —COOR₇ in the 6-position and a group represented by the formula: —CONH— in the 5-position, and having a group represented by the formula: —COOR₄ or —COOR₈ in the 6″-position and a group represented by the formula: —CONH-A₂ (or a group represented by the chemical formula (D-1))—in the 5″-position.

A repeating unit represented by the chemical formula (1) is a repeating unit represented by the chemical formula (3) in which A₁ is a group represented by the following chemical formula (D-1), and a repeating unit represented by the chemical formula (2) is a repeating unit represented by the chemical formula (4) in which A₂ is a group represented by the following chemical formula (D-1):

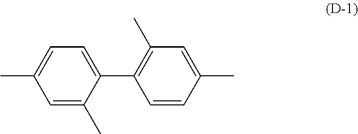

### Advantageous Effects of Invention

According to the present invention, there may be provided a polyimide film and a polyimide which have excellent transparency and excellent mechanical properties, specifically a tensile modulus of elasticity and a load at break, and the like. In addition, according to the present invention, there may be provided a polyimide precursor and a polyimide precursor composition from which a polyimide film having excellent transparency and excellent mechanical properties, specifically a tensile modulus of elasticity and a load at break, and the like, may be obtained.

The polyimide film of the present invention, and the polyimide film obtained from the polyimide precursor or the polyimide precursor composition of the present invention (hereinafter, sometimes collectively referred to as “the polyimide film of the present invention”) have high transparency and excellent mechanical properties such as a tensile modulus of elasticity and a load at break. In addition, the polyimide film of the present invention usually has a relatively low coefficient of linear thermal expansion. Accordingly, the polyimide film of the present invention may be suitably used, for example, as a cover sheet (protective film) for a display screen, and as a substrate for a display, a touch panel, or a solar battery.

### DESCRIPTION OF EMBODIMENTS

### <Polyimide Film of the First Embodiment of the Present Invention>

The polyimide film of the first embodiment of the present invention is a film consisting essentially of a polyimide comprising a repeating unit represented by the chemical formula (1) in an amount of 50 mol % or more relative to the total repeating units, or a polyimide comprising a repeating unit represented by the chemical formula (1) and a repeating unit represented by the chemical formula (2) in an amount of 50 mol % or more relative to the total repeating units, and has a YI (yellowness index) of 4 or less, a tensile modulus of elasticity of 4 GPa or more, and a load at break of 10 N or more.

The YI (yellowness index) of the polyimide film is preferably 3.5 or less, more preferably 3 or less, more preferably 2.8 or less, particularly preferably 2.5 or less. The lower limit of the YI (yellowness index) may be, but not limited to, 0.5 or more, or 1.0 or more, for example. The YI (yellowness index) as used herein is a value measured in accordance with ASTEM E313 standard with a light source of D65 and a viewing angle of 2°.

The tensile modulus of elasticity of the polyimide film is preferably 4.5 GPa or more, more preferably 5 GPa or more, more preferably 5.3 GPa or more, more preferably 5.5 GPa or more, particularly preferably 5.8 GPa or more. The upper limit of the tensile modulus of elasticity may be, but not limited to, 30 GPa or less, or 10 GPa or less, for example. The tensile modulus of elasticity as used herein is a value measured at a distance between chucks of 30 mm and a tensile speed of 2 mm/min using a piece which is obtained by cutting the polyimide film to the dumbbell shape of IEC-540(S) standard as a test piece (width: 4 mm).

In general, a polyimide film may be suitably used as a film when the load at break of the polyimide film is 10 N or more, and the load at break of the polyimide film is preferably 15 N or more. The upper limit of the load at break may be, but not limited to, 500 N or less, or 100 N or less, for example. The load at break as used herein is a value measured at a distance between chucks of 30 mm and a tensile speed of 2 mm/min using a piece which is obtained by cutting the polyimide film to the dumbbell shape of IEC-540(S) standard as a test piece (width: 4 mm).

There had not been such a polyimide film which has both low YI (yellowness index), or high transparency, and high modulus of elasticity, and furthermore has a load at break required for the use as a film.

In addition, the haze of the polyimide film is preferably 3% or less, more preferably 2% or less, more preferably 1.5% or less, particularly preferably less than 1%. In the case where the polyimide film is used in display application, for example, the light may be scattered and the image may be blurred when the haze is as high as more than 3%. The lower limit of the haze may be, but not limited to, 0.01% or more, or 0.05% or more, for example. The haze as used herein is a value measured in accordance with JIS K7136 standard.

Additionally, the light transmittance at 400 nm of the polyimide film is preferably, but not limited to, 75% or more, more preferably 78% or more, more preferably 80% or more, particularly preferably more than 80%.

In addition, the elongation at break of the polyimide film is generally preferably 2.5% or more, more preferably 3% or more because the polyimide film may be suitably used as a film. The upper limit of the elongation at break may be, but not limited to, 100% or less, or 30% or less, for example.

Additionally, the coefficient of linear thermal expansion from 100° C. to 250° C. of the polyimide film is preferably, but not limited to, 45 ppm/K or less, more preferably 40 ppm/K or less, more preferably 35 ppm/K or less, particularly preferably 30 ppm/K or less. When the coefficient of linear thermal expansion is great, the difference in coefficient of linear thermal expansion between the polyimide and a conductive material such as a metal is great, and therefore a trouble such as an increase in warpage may occur during the formation of a circuit board, for example.

The 5% weight loss temperature of the polyimide film, which is the index of the heat resistance, is preferably, but not limited to, 375° C. or more, more preferably 380° C. or more, more preferably 400° C. or more, particularly preferably 420° C. or more. In the case where a gas barrier film, or the like is formed on the polyimide for the formation of a transistor on the polyimide, or the like, swelling may occur between the polyimide and the barrier film due to outgassing associated with the decomposition of the polyimide when the heat resistance is low.

The thickness of the polyimide film is preferably 5 m to 200 μm. The polyimide film of the present invention usually tends to have excellent transparency and an excellent modulus of elasticity, but have a reduced load at break as the polyimide film is thinner. The thickness of the polyimide film may be appropriately selected depending on the intended use, and is generally more preferably 10 μm to 150 μm.

It becomes possible to obtain the polyimide film of the present invention, for example, by producing a polyimide by heating a polyimide precursor composition which comprises a precursor of a polyimide comprising a repeating unit represented by the chemical formula (1) in an amount of 50 mol % or more relative to the total repeating units (i.e., a polyimide precursor comprising a repeating unit represented by the chemical formula (1A) in an amount of 50 mol % or more relative to the total repeating units) or a precursor of a polyimide comprising a repeating unit represented by the chemical formula (1) and a repeating unit represented by the chemical formula (2) in an amount of 50 mol % or more relative to the total repeating units (i.e., a polyimide precursor comprising a repeating unit represented by the chemical formula (1A) and a repeating unit represented by the chemical formula (2A) in an amount of 50 mol % or more relative to the total repeating units), and an imidazole compound and/or a trialkylamine compound. This polyimide and the production method will be described later in <Polyimide precursor composition and Polyimide of the second embodiment of the present invention>.

It also becomes possible to obtain the polyimide film of the present invention by forming the film of a polyimide comprising a repeating unit represented by the chemical formula (1) and a repeating unit represented by the chemical formula (2) in an amount of 50 mol % or more relative to the total repeating units, even though an imidazole compound and a trialkylamine compound are not used. This polyimide and the production method will be described later in <Polyimide precursor and Polyimide of the third embodiment of the present invention>.

The polyimide film of the first embodiment of the present invention, however, is not limited to the films produced by these production methods. For example, it may also be possible to obtain the polyimide film of the first embodiment of the present invention by copolymerizing a specific monomer component, specifically 4,4′-oxydianiline, or the like, in not more than a specific amount, for example, in an amount of 15 mol % or less, or 10 mol % or less.

As described above, the polyimide film of the first embodiment of the present invention consists essentially of a polyimide comprising a repeating unit represented by the chemical formula (1) in an amount of 50 mol % or more relative to the total repeating units, or a polyimide comprising a repeating unit represented by the chemical formula (1) and a repeating unit represented by the chemical formula (2) in an amount of 50 mol % or more relative to the total repeating units. The amount of the repeating unit represented by the chemical formula (1), or the total amount of the repeating unit represented by the chemical formula (1) and the repeating unit represented by the chemical formula (2) is preferably 70 mol % to 100 mol %, more preferably 80 mol % to 100 mol %, particularly preferably 90 mol % to 100 mol %, relative to the total repeating units.

In addition, it is preferred that the polyimide of the polyimide film of the first embodiment of the present invention comprises a repeating unit represented by the chemical formula (3), including a repeating unit represented by the chemical formula (1) [a repeating unit represented by the chemical formula (3) in which A₁ is a group represented by the chemical formula (D-1)], preferably in an amount of 90 mol % or more, more preferably 95 mol % or more, relative to the total repeating units, or comprises a repeating unit represented by the chemical formula (3) and a repeating unit represented by the chemical formula (4), including a repeating unit represented by the chemical formula (1) [a repeating unit represented by the chemical formula (3) in which A₁ is a group represented by the chemical formula (D-1)], and a repeating unit represented by the chemical formula (2) [a repeating unit represented by the chemical formula (4) in which A₂ is a group represented by the chemical formula (D-1)], preferably in an amount of 90 mol % or more, more preferably 95 mol % or more, relative to the total repeating units. In one embodiment, it is particularly preferred that the polyimide of the polyimide film of the first embodiment of the present invention consists of a repeating unit represented by the chemical formula (3) [including a repeating unit represented by the chemical formula (1)], or consists of a repeating unit represented by the chemical formula (3) and a repeating unit represented by the chemical formula (4) [including a repeating unit represented by the chemical formula (1) and a repeating unit represented by the chemical formula (2)].

The polyimide may comprise one type of repeating unit represented by the chemical formula (3), or comprise at least two types of repeating units represented by the chemical formula (3) in which A₁ is different, and may comprise one type of repeating unit represented by the chemical formula (4), or comprise at least two types of repeating units represented by the chemical formula (4) in which A₂ is different.

As the A₁ in the chemical formula (3) and the A₂ in the chemical formula (4) other than the group represented by the chemical formula (D-1), a divalent group having an aromatic ring which has 6 to 40 carbon atoms is preferred, and a group represented by the following chemical formula (A-1) is particularly preferred.

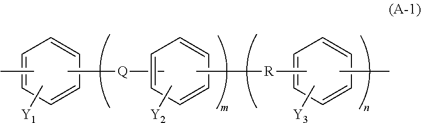

wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

The tetracarboxylic acid component to provide a repeating unit represented by the chemical formula (1) and a repeating unit represented by the chemical formula (3) is 1,2,3,4-cyclobutane tetracarboxylic acid, or the like (The term “tetracarboxylic acid, or the like” means tetracarboxylic acid, and tetracarboxylic acid derivatives including tetracarboxylic dianhydride, tetracarboxylic acid silyl ester, tetracarboxylic acid ester and tetracarboxylic acid chloride). The tetracarboxylic acid component to provide a repeating unit represented by the chemical formula (2) and a repeating unit represented by the chemical formula (4) is norbornane-2-spiro-α-cyclopentanone-α′-spiro-2″-norbornane-5,5″,6,6″-tetracarboxylic acid, or the like. The diamine component to provide a repeating unit represented by the chemical formula (1) [a repeating unit represented by the chemical formula (3) in which A₁ is a group represented by the chemical formula (D-1)] and a repeating unit represented by the chemical formula (2) [a repeating unit represented by the chemical formula (4) in which A₂ is a group represented by the chemical formula (D-1)] is 2,2′-dimethyl-4,4′-diaminobiphenyl (m-tolidine).

In other words, the polyimide of the polyimide film of the first embodiment of the present invention is a polyimide obtained from

a tetracarboxylic acid component comprising 1,2,3,4-cyclobutane tetracarboxylic acid, or the like, or alternatively, a tetracarboxylic acid component comprising 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like; and

a diamine component comprising 2,2′-dimethyl-4,4′-diaminobiphenyl (m-tolidine),

with the proviso that the amount of 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like in the tetracarboxylic acid component, and the amount of 2,2′-dimethyl-4,4′-diaminobiphenyl in the diamine component are selected such that the amount of the repeating unit represented by the chemical formula (1), or the total amount of the repeating unit represented by the chemical formula (1) and the repeating unit represented by the chemical formula (2) in the obtained polyimide is 50 mol % or more relative to the total repeating units.

As the tetracarboxylic acid component to provide a repeating unit represented by the chemical formula (1) [a repeating unit represented by the chemical formula (3) in which A₁ is a group represented by the chemical formula (D-1)] and a repeating unit represented by the chemical formula (3), 1,2,3,4-cyclobutane tetracarboxylic acid, or the like may be used alone or in combination of a plurality of types. As the tetracarboxylic acid component to provide a repeating unit represented by the chemical formula (2) [a repeating unit represented by the chemical formula (4) in which A₂ is a group represented by the chemical formula (D-1)] and a repeating unit represented by the chemical formula (4), norbornane-2-spiro-α-cyclopentanone-α′-spiro-2″-norbornane-5,5″,6,6″-tetracarboxylic acid, or the like may be used alone or in combination of a plurality of types. As for norbornane-2-spiro-α-cyclopentanone-α′-spiro-2″-norbornane-5,5″,6,6″-tetracarboxylic acid, or the like, trans-endo-endo-norbornane-2-spiro-α-cyclopentanone-α′-spiro-2″-norbornane-5,5″,6,6″-tetracarboxylic acid, or the like and/or cis-endo-endo-norbornane-2-spiro-α-cyclopentanone-α′-spiro-2″-norbornane-5,5″,6,6″-tetracarboxylic acid, or the like are more preferred.

The diamine component to provide a repeating unit of the chemical formula (3) or the chemical formula (4) other than a repeating unit represented by the chemical formula (1) and a repeating unit represented by the chemical formula (2), that is, having a group other than a group represented by the chemical formula (D-1) as A₁ or A₂ is a diamine having an aromatic ring (aromatic diamine), and preferably comprises a diamine to provide a repeating unit of the chemical formula (3) in which A₁ is a group represented by the chemical formula (A-1) and a repeating unit of the chemical formula (4) in which A₂ is a group represented by the chemical formula (A-1).

The diamine component to provide a repeating unit of the chemical formula (3) in which A₁ is a group represented by the chemical formula (A-1) and a repeating unit of the chemical formula (4) in which A₂ is a group represented by the chemical formula (A-1) has an aromatic ring, and when the diamine component has a plurality of aromatic rings, the aromatic rings are independently linked to each other by direct bond, amide bond, or ester bond. When the aromatic rings are linked at the 4-position relative to the amino group or the linking group between the aromatic rings, the obtained polyimide has a linear structure and may have low linear thermal expansibility, although the linking position of the aromatic rings is not limited thereto. Meanwhile, the aromatic ring may be substituted by methyl or trifluoromethyl. The substitution position is not particularly limited.

Examples of the diamine component to provide a repeating unit of the chemical formula (3) in which A₁ is a group represented by the chemical formula (A-1) and a repeating unit of the chemical formula (4) in which A₂ is a group represented by the chemical formula (A-1) include, but not limited to, p-phenylenediamine, m-phenylenediamine, benzidine, 3,3′-diamino-biphenyl, 2,2′-bis(trifluoromethyl)benzidine, 3,3′-bis(trifluoromethyl)benzidine, 4,4′-diaminobenzanilide, 3,4′-diaminobenzanilide, N,N′-bis(4-aminophenyl) terephthalamide, N,N′-p-phenylene bis(p-aminobenzamide), 4-aminophenoxy-4-diaminobenzoate, bis(4-aminophenyl)terephthalate, biphenyl-4,4′-dicarboxylic acid bis(4-aminophenyl)ester, p-phenylene bis(p-aminobenzoate), bis(4-aminophenyl)-[1,1′-biphenyl]-4,4′-dicarboxylate, and [1, 1′-biphenyl]-4,4′-diyl bis(4-aminobenzoate). The diamine component may be used alone or in combination of a plurality of types. Among them, p-phenylenediamine, o-tolidine, 4,4′-diaminobenzanilide, 4-aminophenoxy-4-diaminobenzoate, 2,2′-bis(trifluoromethyl)benzidine, benzidine, N,N′-bis(4-aminophenyl) terephthalamide, and biphenyl-4,4′-dicarboxylic acid bis(4-aminophenyl)ester are preferred, and p-phenylenediamine, 4,4′-diaminobenzanilide, and 2,2′-bis(trifluoromethyl)benzidine are more preferred. These diamines may be used alone or in combination of a plurality of types.

As the diamine component to provide a repeating unit of the chemical formula (3) or the chemical formula (4), other aromatic diamines other than the diamine component which provides the one in which A₁ or A₂ is a structure of the chemical formula (D-1) or the chemical formula (A-1) may be used. Examples of the other diamine component include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis(4-(4-aminophenoxy)phenyl) hexafluoropropane, 2,2-bis(4-aminophenyl)hexafluoropropane, bis(4-aminophenyl)sulfone, 3,3′-bis(trifluoromethyl)benzidine, 3,3′-bis((aminophenoxy)phenyl)propane, 2, 2′-bis(3-amino-4-hydroxyphenyl) hexafluoropropane, bis(4-(4-aminophenoxy)diphenyl) sulfone, bis(4-(3-aminophenoxy)diphenyl) sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 6,6′-bis(3-aminophenoxy)-3,3,3′,3′-tetramethyl-1,1′-spirobiindane, and 6,6′-bis(4-aminophenoxy)-3,3,3′,3′-tetramethyl-1,1′-spirobiindane, and derivatives thereof. These may be used alone or in combination of a plurality of types. Among them, 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, and 4,4′-bis(3-aminophenoxy)biphenyl are preferred, and 4,4′-oxydianiline, and 4,4′-bis(4-aminophenoxy)biphenyl are particularly preferred.

In one embodiment, in view of the properties of the obtained polyimide, the ratio of the diamine component to provide a structure of the chemical formula (A-1) may be preferably, for example, 65 mol % or less, preferably 75 mol % or less, more preferably 80 mol % or less, particularly preferably 90 mol % or less, in total, relative to 100 mol % of the diamine component to provide a repeating unit of the chemical formula (3) or the chemical formula (4). For example, other diamines such as a diamine having an ether bond (—O—), including 4,4′-oxydianiline and 4,4′-bis(4-aminophenoxy)biphenyl, may be preferably used, for example, in an amount of 35 mol % or less, preferably 25 mol % or less, more preferably 20 mol % or less, particularly preferably 10 mol % or less, relative to 100 mol % of the diamine component to provide a repeating unit of the chemical formula (3) or the chemical formula (4).

The polyimide of the first embodiment of the present invention may comprise one or more of other repeating units other than the repeating units represented by the chemical formula (1), the chemical formula (2), the chemical formula (3), or the chemical formula (4).

Other aromatic or aliphatic tetracarboxylic acids, or the like may be used as the tetracarboxylic acid component to provide the other repeating unit. Examples thereof include derivatives of, and dianhydrides of 2,2-bis(3,4-dicarboxyphenyl)hexafluoropropane, 4-(2,5-dioxotetrahydrofuran-3-yl)-1,2,3,4-tetrahydronaphthalene-1,2-dicarboxylic acid, pyromellitic acid, 3,3′,4,4′-benzophenone tetracarboxylic acid, 3,3′,4,4′-biphenyl tetracarboxylic acid, 2,3,3′,4′-biphenyl tetracarboxylic acid, 4,4′-oxydiphthalic acid, bis(3,4-dicarboxyphenyl)sulfone dianhydride, m-terphenyl-3,4,3′,4′-tetracarboxylic dianhydride, p-terphenyl-3,4,3′,4′-tetracarboxylic dianhydride, biscarboxyphenyl dimethylsilane, bis dicarboxy phenoxy diphenyl sulfide, sulfonyl diphthalic acid, isopropylidene diphenoxy bis phthalic acid, cyclohexane-1,2,4, 5-tetracarboxylic acid, [1,1′-bi(cyclohexane)]-3,3′,4,4′-tetracarboxylic acid, [1,1′-bi(cyclohexane)]-2,3,3′,4′-tetracarboxylic acid, [1,1′-bi(cyclohexane)]-2,2′,3,3′-tetracarboxylic acid, 4,4′-methylene bis(cyclohexane-1,2-dicarboxylic acid), 4,4′-(propane-2, 2-diyl)bis(cyclohexane-1,2-dicarboxylic acid), 4,4′-oxy bis(cyclohexane-1,2-dicarboxylic acid), 4,4′-thio bis(cyclohexane-1,2-dicarboxylic acid), 4,4′-sulfonyl bis(cyclohexane-1,2-dicarboxylic acid), 4,4′-(dimethylsilanediyl)bis(cyclohexane-1,2-dicarboxylic acid), 4,4′-(tetrafluoropropane-2,2-diyl)bis(cyclohexane-1,2-dicarboxylic acid), octahydropentalene-1,3,4, 6-tetracarboxylic acid, bicyclo[2.2.1]heptane-2,3,5,6-tetracarboxylic acid, 6-(carboxymethyl)bicyclo[2.2.1]heptane-2,3, 5-tricarboxylic acid, bicyclo[2.2.2]octane-2,3,5,6-tetracarboxylic acid, bicyclo[2.2.2]octa-5-ene-2,3,7,8-tetracarboxylic acid, tricyclo[4.2.2.02,5]decane-3,4,7,8-tetracarboxylic acid, tricyclo[4.2.2.02,5]deca-7-ene-3,4,9,10-tetracarboxylic acid, 9-oxatricyclo[4.2.1.02,5]nonane-3,4,7,8-tetracarboxylic acid, and decahydro-1,4:5,8-dimethanonaphthalene-2,3,6,7-tetracarboxylic acid, and the like. These may be used alone or in combination of a plurality of types.

Additionally, in the case where the diamine component to be combined therewith is an aliphatic diamine, derivatives of, and dianhydrides of 1,2,3,4-cyclobutane tetracarboxylic acid, or the like and norbornane-2-spiro-α-cyclopentanone-α′-spiro-2″-norbornane-5,5″,6,6″-tetracarboxylic acid, or the like may also be used as the tetracarboxylic acid component to provide the other repeating unit.

The diamine component to provide the other repeating unit may be the diamine described as the diamine component to provide a repeating unit of the chemical formula (3) in which A₁ is a group represented by the chemical formula (A-1) and a repeating unit of the chemical formula (4) in which A₂ is a group represented by the chemical formula (A-1), that is, 2,2′-dimethyl-4,4′-diaminobiphenyl.

Other aromatic or aliphatic diamines may be used as the diamine component to provide the other repeating unit. Examples thereof include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis(4-(4-aminophenoxy)phenyl)hexafluoropropane, 2, 2-bis(4-aminophenyl) hexafluoropropane, bis(4-aminophenyl)sulfone, 3,3′-bis(trifluoromethyl) benzidine, 3,3′-bis((aminophenoxy)phenyl)propane, 2,2′-bis(3-amino-4-hydroxyphenyl)hexafluoropropane, bis(4-(4-aminophenoxy)diphenyl)sulfone, bis(4-(3-aminophenoxy)diphenyl)sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 1,4-diaminocyclohexane, 1,4-diamino-2-methylcyclohexane, 1,4-diamino-2-ethylcyclohexane, 1,4-diamino-2-n-propylcyclohexane, 1,4-diamino-2-isopropylcyclohexane, 1,4-diamino-2-n-butylcyclohexane, 1,4-diamino-2-isobutylcyclohexane, 1,4-diamino-2-sec-butylcyclohexane, 1,4-diamino-2-tert-butylcyclohexane, 1,2-diaminocyclohexane, 1,3-diaminocyclobutane, 1,4-bis(aminomethyl)cyclohexane, 1,3-bis(aminomethyl) cyclohexane, diaminobicycloheptane, diaminomethylbicycloheptane, diaminooxybicycloheptane, diaminomethyloxybicycloheptane, isophoronediamine, diaminotricyclodecane, diaminomethyltricyclodecane, bis(aminocyclohexyl) methane, bis(aminocyclohexyl)isopropylidene, 6,6′-bis(3-aminophenoxy)-3,3, 3′,3′-tetramethyl-1,1′-spirobiindane, and 6,6′-bis(4-aminophenoxy)-3,3, 3′,3′-tetramethyl-1,1′-spirobiindane, and derivatives thereof. These may be used alone or in combination of a plurality of types.

The polyimide film of the first embodiment of the present invention may comprise a filler such as an inorganic particle, including silica, a dye, a pigment, a coupling agent such as a silane coupling agent, a primer, a flame retardant, a defoaming agent, a leveling agent, a rheology control agent (flow-promoting agent), a releasing agent, and the like, as necessary.

One concrete example of the method for producing the polyimide film of the first embodiment of the present invention will be described in Section <Polyimide precursor composition and Polyimide of the second embodiment of the present invention>, <Polyimide precursor and Polyimide of the third embodiment of the present invention> and <Method for producing a polyimide film/base laminate, or a polyimide film and Substrate>.

The polyimide film of the first embodiment of the present invention is flexible, and has high transparency and excellent mechanical properties such as a tensile modulus of elasticity and a load at break, and has a low coefficient of linear thermal expansion and excellent heat resistance. Accordingly, the polyimide film of the present invention may be suitably used, for example, as a cover sheet (protective film) for a display screen, and as a substrate for a display, a touch panel, or a solar battery.

### <Polyimide Precursor Composition and Polyimide of the Second Embodiment of the Present Invention>

The polyimide precursor composition of the second embodiment of the present invention comprises a polyimide precursor comprising a repeating unit represented by the chemical formula (1A) in an amount of 50 mol % or more relative to the total repeating units, or a polyimide precursor comprising a repeating unit represented by the chemical formula (1A) and a repeating unit represented by the chemical formula (2A) in an amount of 50 mol % or more relative to the total repeating units; and an imidazole compound and/or a trialkylamine compound. In the polyimide precursor composition of the second embodiment of the present invention, however, the polyimide precursor comprising a repeating unit represented by the chemical formula (1A) and a repeating unit represented by the chemical formula (2A) in an amount of 50 mol % or more relative to the total repeating units may comprise a repeating unit represented by the chemical formula (1A) and a repeating unit represented by the chemical formula (2A) in an amount of 50 mol % or more relative to the total repeating units as a whole, and may comprise a polyimide precursor comprising only a repeating unit represented by the chemical formula (1A) and/or a polyimide precursor comprising only a repeating unit represented by the chemical formula (2A).

The polyimide of the second embodiment of the present invention is a polyimide comprising a repeating unit represented by the chemical formula (1) in an amount of 50 mol % or more relative to the total repeating units, or a polyimide comprising a repeating unit represented by the chemical formula (1) and a repeating unit represented by the chemical formula (2) in an amount of 50 mol % or more relative to the total repeating units, and is obtained by heating a polyimide precursor composition comprising a precursor of the polyimide, and an imidazole compound and/or a trialkylamine compound. In other words, the polyimide of the second embodiment of the present invention is the one obtained from the polyimide precursor composition of the second embodiment of the present invention.

The polyimide precursor composition of the second embodiment of the present invention and the polyimide of the second embodiment of the present invention, however, is not limited to the ones from which the polyimide film of the first embodiment of the present invention may be obtained.

The polyimide precursor composition of the second embodiment of the present invention comprises the polyimide precursor as described above, and an imidazole compound and/or a trialkylamine compound. The amount of the imidazole compound and/or the trialkylamine compound is preferably less than 4 mol, in total, relative to 1 mol of the repeating unit of the polyimide precursor. In the case of a polyimide for which transparency is required, the use of additives which may cause coloring is not desired. However, the mechanical properties of the obtained polyimide film may be improved, while maintaining the high transparency, by adding an imidazole compound and/or a trialkylamine compound to a polyimide precursor composition preferably in a ratio of less than 4 mol, more preferably 0.05 mol to 1 mol, relative to 1 mol of the repeating unit of the polyimide precursor. In other words, a polyimide having better mechanical properties, while maintaining the high transparency, may be obtained from a polyimide precursor having the same composition.

As described above, the polyimide precursor composition of the second embodiment of the present invention comprises a polyimide precursor comprising a repeating unit represented by the chemical formula (1A) in an amount of 50 mol % or more relative to the total repeating units, or a polyimide precursor comprising a repeating unit represented by the chemical formula (1A) and a repeating unit represented by the chemical formula (2A) in an amount of 50 mol % or more relative to the total repeating units. The amount of the repeating unit represented by the chemical formula (1A), or the total amount of the repeating unit represented by the chemical formula (1A) and the repeating unit represented by the chemical formula (2A) is preferably 70 mol % to 100 mol %, more preferably 80 mol % to 100 mol %, particularly preferably 90 mol % to 100 mol %, relative to the total repeating units.

In addition, it is preferred that the polyimide precursor of the polyimide precursor composition of the second embodiment of the present invention comprises a repeating unit represented by the chemical formula (3A), including a repeating unit represented by the chemical formula (1A) [a repeating unit represented by the chemical formula (3A) in which A₁ is a group represented by the chemical formula (D-1)], preferably in an amount of 90 mol % or more, more preferably 95 mol % or more, relative to the total repeating units, or comprises a repeating unit represented by the chemical formula (3A) and a repeating unit represented by the chemical formula (4A), including a repeating unit represented by the chemical formula (1A) [a repeating unit represented by the chemical formula (3A) in which A₁ is a group represented by the chemical formula (D-1)], and a repeating unit represented by the chemical formula (2A) [a repeating unit represented by the chemical formula (4A) in which A₂ is a group represented by the chemical formula (D-1)], preferably in an amount of 90 mol % or more, more preferably 95 mol % or more, relative to the total repeating units. In one embodiment, it is particularly preferred that the polyimide precursor of the polyimide precursor composition of the second embodiment of the present invention consists of a repeating unit represented by the chemical formula (3A) [including a repeating unit represented by the chemical formula (1A)], or consists of a repeating unit represented by the chemical formula (3A) and a repeating unit represented by the chemical formula (4A) [including a repeating unit represented by the chemical formula (1A) and a repeating unit represented by the chemical formula (2A)].

The polyimide precursor may comprise one type of repeating unit represented by the chemical formula (3A), or comprise at least two types of repeating units represented by the chemical formula (3A) in which A₁ is different, and may comprise one type of repeating unit represented by the chemical formula (4A), or comprise at least two types of repeating units represented by the chemical formula (4A) in which A₂ is different.

As the A₁ in the chemical formula (3A) and the A₂ in the chemical formula (4A) other than the group represented by the chemical formula (D-1), a divalent group having an aromatic ring which has 6 to 40 carbon atoms is preferred, and a group represented by the following chemical formula (A-1) is particularly preferred.

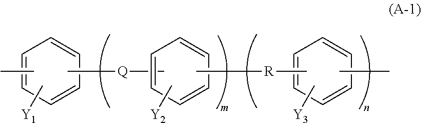

wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

The tetracarboxylic acid component to provide a repeating unit represented by the chemical formula (1A) and a repeating unit represented by the chemical formula (3A) is 1,2,3,4-cyclobutane tetracarboxylic acid, or the like (The term “tetracarboxylic acid, or the like” means tetracarboxylic acid, and tetracarboxylic acid derivatives including tetracarboxylic dianhydride, tetracarboxylic acid silyl ester, tetracarboxylic acid ester and tetracarboxylic acid chloride). The tetracarboxylic acid component to provide a repeating unit represented by the chemical formula (2A) and a repeating unit represented by the chemical formula (4A) is norbornane-2-spiro-α-cyclopentanone-α′-spiro-2″-norbornane-5,5″,6,6″-tetracarboxylic acid, or the like. The diamine component to provide a repeating unit represented by the chemical formula (1A) [a repeating unit represented by the chemical formula (3A) in which A₁ is a group represented by the chemical formula (D-1)] and a repeating unit represented by the chemical formula (2A) [a repeating unit represented by the chemical formula (4A) in which A₂ is a group represented by the chemical formula (D-1)] is 2,2′-dimethyl-4,4′-diaminobiphenyl (m-tolidine).

In other words, the polyimide precursor of the polyimide precursor composition of the second embodiment of the present invention is a polyimide precursor obtained from

a tetracarboxylic acid component comprising 1,2,3,4-cyclobutane tetracarboxylic acid, or the like, or alternatively, a tetracarboxylic acid component comprising 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like; and

a diamine component comprising 2,2′-dimethyl-4,4′-diaminobiphenyl (m-tolidine),

with the proviso that the amount of 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like in the tetracarboxylic acid component, and the amount of 2,2′-dimethyl-4,4′-diaminobiphenyl in the diamine component are selected such that the amount of the repeating unit represented by the chemical formula (1A), or the total amount of the repeating unit represented by the chemical formula (1A) and the repeating unit represented by the chemical formula (2A) in the obtained polyimide precursor is 50 mol % or more relative to the total repeating units.

As the tetracarboxylic acid component to provide a repeating unit represented by the chemical formula (1A) [a repeating unit represented by the chemical formula (3A) in which A₁ is a group represented by the chemical formula (D-1)] and a repeating unit represented by the chemical formula (3A), 1,2,3,4-cyclobutane tetracarboxylic acid, or the like may be used alone or in combination of a plurality of types. As the tetracarboxylic acid component to provide a repeating unit represented by the chemical formula (2A) [a repeating unit represented by the chemical formula (4A) in which A₂ is a group represented by the chemical formula (D-1)] and a repeating unit represented by the chemical formula (4A), norbornane-2-spiro-α-cyclopentanone-α′-spiro-2″-norbornane-5,5″,6,6″-tetracarboxylic acid, or the like may be used alone or in combination of a plurality of types. As for norbornane-2-spiro-α-cyclopentanone-α′-spiro-2″-norbornane-5,5″,6,6″-tetracarboxylic acid, or the like, trans-endo-endo-norbornane-2-spiro-α-cyclopentanone-α′-spiro-2″-norbornane-5,5″,6,6″-tetracarboxylic acid, or the like and/or cis-endo-endo-norbornane-2-spiro-α-cyclopentanone-α′-spiro-2″-norbornane-5,5″,6,6″-tetracarboxylic acid, or the like are more preferred.

The diamine component to provide a repeating unit of the chemical formula (3A) or the chemical formula (4A) other than a repeating unit represented by the chemical formula (1A) and a repeating unit represented by the chemical formula (2A), that is, having a group other than a group represented by the chemical formula (D-1) as A₁ or A₂ is a diamine having an aromatic ring (aromatic diamine), and preferably comprises a diamine to provide a repeating unit of the chemical formula (3A) in which A₁ is a group represented by the chemical formula (A-1) and a repeating unit of the chemical formula (4A) in which A₂ is a group represented by the chemical formula (A-1).

The diamine component to provide a repeating unit of the chemical formula (3A) in which A₁ is a group represented by the chemical formula (A-1) and a repeating unit of the chemical formula (4A) in which A₂ is a group represented by the chemical formula (A-1) has an aromatic ring, and when the diamine component has a plurality of aromatic rings, the aromatic rings are independently linked to each other by direct bond, amide bond, or ester bond. When the aromatic rings are linked at the 4-position relative to the amino group or the linking group between the aromatic rings, the obtained polyimide has a linear structure and may have low linear thermal expansibility, although the linking position of the aromatic rings is not limited thereto. Meanwhile, the aromatic ring may be substituted by methyl or trifluoromethyl. The substitution position is not particularly limited.

Examples of the diamine component to provide a repeating unit of the chemical formula (3A) in which A₁ is a group represented by the chemical formula (A-1) and a repeating unit of the chemical formula (4A) in which A₂ is a group represented by the chemical formula (A-1) include, but not limited to, p-phenylenediamine, m-phenylenediamine, benzidine, 3,3′-diamino-biphenyl, 2,2′-bis(trifluoromethyl)benzidine, 3,3′-bis(trifluoromethyl) benzidine, 4,4′-diaminobenzanilide, 3,4′-diaminobenzanilide, N,N′-bis(4-aminophenyl)terephthalamide, N,N′-p-phenylene bis(p-aminobenzamide), 4-aminophenoxy-4-diaminobenzoate, bis(4-aminophenyl)terephthalate, biphenyl-4,4′-dicarboxylic acid bis(4-aminophenyl) ester, p-phenylene bis(p-aminobenzoate), bis(4-aminophenyl)-[1,1′-biphenyl]-4,4′-dicarboxylate, and [1,1′-biphenyl]-4,4′-diyl bis(4-aminobenzoate). The diamine component may be used alone or in combination of a plurality of types. Among them, p-phenylenediamine, o-tolidine, 4,4′-diaminobenzanilide, 4-aminophenoxy-4-diaminobenzoate, 2,2′-bis(trifluoromethyl)benzidine, benzidine, N,N′-bis(4-aminophenyl)terephthalamide, and biphenyl-4,4′-dicarboxylic acid bis(4-aminophenyl)ester are preferred, and p-phenylenediamine, 4,4′-diaminobenzanilide, and 2,2′-bis(trifluoromethyl)benzidine are more preferred. These diamines may be used alone or in combination of a plurality of types.

As the diamine component to provide a repeating unit of the chemical formula (3A) or the chemical formula (4A), other aromatic diamines other than the diamine component which provides the one in which A₁ or A₂ is a structure of the chemical formula (D-1) or the chemical formula (A-1) may be used. Examples of the other diamine component include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis(4-(4-aminophenoxy)phenyl) hexafluoropropane, 2,2-bis(4-aminophenyl)hexafluoropropane, bis(4-aminophenyl)sulfone, 3,3′-bis(trifluoromethyl)benzidine, 3,3′-bis((aminophenoxy)phenyl)propane, 2, 2′-bis(3-amino-4-hydroxyphenyl) hexafluoropropane, bis(4-(4-aminophenoxy)diphenyl) sulfone, bis(4-(3-aminophenoxy)diphenyl) sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 6,6′-bis(3-aminophenoxy)-3,3,3′,3′-tetramethyl-1,1′-spirobiindane, and 6,6′-bis(4-aminophenoxy)-3,3,3′,3′-tetramethyl-1,1′-spirobiindane, and derivatives thereof. These may be used alone or in combination of a plurality of types. Among them, 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, and 4,4′-bis(3-aminophenoxy)biphenyl are preferred, and 4,4′-oxydianiline, and 4,4′-bis(4-aminophenoxy)biphenyl are particularly preferred.

In one embodiment, in view of the properties of the obtained polyimide, the ratio of the diamine component to provide a structure of the chemical formula (A-1) may be preferably, for example, 65 mol % or less, preferably 75 mol % or less, more preferably 80 mol % or less, particularly preferably 90 mol % or less, in total, relative to 100 mol % of the diamine component to provide a repeating unit of the chemical formula (3A) or the chemical formula (4A). For example, other diamines such as a diamine having an ether bond (—O—), including 4,4′-oxydianiline and 4,4′-bis(4-aminophenoxy)biphenyl, may be preferably used, for example, in an amount of 35 mol % or less, preferably 25 mol % or less, more preferably 20 mol % or less, particularly preferably 10 mol % or less, relative to 100 mol % of the diamine component to provide a repeating unit of the chemical formula (3A) or the chemical formula (4A).

The polyimide precursor of the second embodiment of the present invention may comprise one or more of other repeating units other than the repeating units represented by the chemical formula (1A), the chemical formula (2A), the chemical formula (3A), or the chemical formula (4A).

Other aromatic or aliphatic tetracarboxylic acids, or the like may be used as the tetracarboxylic acid component to provide the other repeating unit. Examples thereof include those described above as the tetracarboxylic acid component to provide the other repeating unit in the polyimide of the first embodiment of the present invention. These may be used alone or in combination of a plurality of types.

Additionally, in the case where the diamine component to be combined therewith is an aliphatic diamine, derivatives of, and dianhydrides of 1,2,3,4-cyclobutane tetracarboxylic acid, or the like and norbornane-2-spiro-α-cyclopentanone-α′-spiro-2″-norbornane-5,5″,6,6″-tetracarboxylic acid, or the like may also be used as the tetracarboxylic acid component to provide the other repeating unit.

The diamine component to provide the other repeating unit may be the diamine described as the diamine component to provide a repeating unit of the chemical formula (3A) in which A₁ is a group represented by the chemical formula (A-1) and a repeating unit of the chemical formula (4A) in which A₂ is a group represented by the chemical formula (A-1), that is, 2,2′-dimethyl-4,4′-diaminobiphenyl.

Other aromatic or aliphatic diamines may be used as the diamine component to provide the other repeating unit. Examples thereof include those described above as the diamine component to provide the other repeating unit in the polyimide of the first embodiment of the present invention. These may be used alone or in combination of a plurality of types.

In the polyimide precursor of the second embodiment of the present invention, R₁ and R₂ in the chemical formula (1A), R₃ and R₄ in the chemical formula (2A), R₅ and R₆ in the chemical formula (3A), and R₇ and R₈ in the chemical formula (4A) are each independently hydrogen, an alkyl group having 1 to 6 carbon atoms, preferably having 1 to 3 carbon atoms, or an alkylsilyl group having 3 to 9 carbon atoms. As for R₁ and R₂, R₃ and R₄, R₅ and R₆, and R₇ and R₈, the types of the functional groups and the introduction ratio of the functional groups may be changed by the production method as described later.

In the case where R₁ and R₂, R₃ and R₄, R₅ and R₆, and R₇ and R₈ are hydrogen, a polyimide tends to be easily produced therefrom.

Meanwhile, in the case where R₁ and R₂, R₃ and R₄, R₅ and R₆, and R₇ and R₈ are alkyl group having 1 to 6 carbon atoms, preferably having 1 to 3 carbon atoms, the polyimide precursor tends to have excellent storage stability. In this case, R₁ and R₂, R₃ and R₄, R₅ and R₆, and R₇ and R₈ are more preferably methyl or ethyl.

Additionally, in the case where R₁ and R₂, R₃ and R₄, R₅ and R₆, and R₇ and R₈ are alkylsilyl group having 3 to 9 carbon atoms, the polyimide precursor tends to have excellent solubility. In this case, R₁ and R₂, R₃ and R₄, R₅ and R₆, and R₇ and R₈ are more preferably trimethylsilyl or t-butyldimethylsilyl.

When an alkyl group or an alkylsilyl group is introduced, R₁ and R₂, R₃ and R₄, R₅ and R₆, and R₇ and R₈ each may be converted into an alkyl group or an alkylsilyl group in a ratio of 25% or more, preferably 50% or more, more preferably 75% or more, although the introduction ratio of the functional groups is not limited thereto.

According to the chemical structures which R₁ and R₂, R₃ and R₄, R₅ and R₆, and R₇ and R₈ have, the polyimide precursors of the second embodiment of the present invention may be classified into

1) polyamic acid (R₁ and R₂, R₃ and R₄, R₅ and R₆, and R₇ and R₈ are hydrogen),

2) polyamic acid ester (at least part of R₁ and R₂, R₃ and R₄, R₅ and R₆, and R₇ and R₈ is alkyl group), and

3) 4) polyamic acid silyl ester (at least part of R₁ and R₂, R₃ and R₄, R₅ and R₆, and R₇ and R₈ is alkylsilyl group).

Each class of the polyimide precursors of the second embodiment of the present invention may be easily produced by the production methods as described below. However, the method for producing the polyimide precursor of the second embodiment of the present invention is not limited to the production methods as described below.

1) Polyamic Acid

The polyimide precursor of the second embodiment of the present invention may be suitably obtained, in the form of a polyimide precursor solution composition, by reacting a tetracarboxylic dianhydride as a tetracarboxylic acid component and a diamine component in a substantially equimolar amount, preferably in a molar ratio of the diamine component to the tetracarboxylic acid component [molar number of the diamine component/molar number of the tetracarboxylic acid component] of 0.90 to 1.10, more preferably 0.95 to 1.05, in a solvent at a relatively low temperature of 120° C. or less, for example, while suppressing the imidization.

More specifically, the polyimide precursor may be obtained by dissolving the diamine in an organic solvent, adding the tetracarboxylic dianhydride to the resulting solution gradually while stirring the solution, and then stirring the solution at a temperature of 0° C. to 120° C., preferably 5° C. to 80° C., for 1 hour to 72 hours, although the production method is not limited thereto. When they are reacted at a temperature of 80° C. or more, the molecular weight may vary depending on the temperature history in the polymerization and the imidization may proceed by heat, and therefore the polyimide precursor may not be stably produced. The sequence of the addition of the diamine and the tetracarboxylic dianhydride in the production method as described above is preferred because the molecular weight of the polyimide precursor is apt to increase. Meanwhile, the sequence of the addition of the diamine and the tetracarboxylic dianhydride in the production method as described above may be reversed, and the sequence is preferred because the amount of the precipitate is reduced.

In addition, when the diamine component is excessive in the molar ratio of the tetracarboxylic acid component to the diamine component, a carboxylic acid derivative may be added in an amount which substantially corresponds to the excessive molar number of the diamine component, as necessary, so that the molar ratio of the tetracarboxylic acid component to the diamine component is closer to the substantially equimolar amount. As the carboxylic acid derivative to be used herein, tetracarboxylic acids, which do not substantially increase the viscosity of the polyimide precursor solution, that is, do not substantially involve the molecular chain extension, or tricarboxylic acids and anhydrides thereof, and dicarboxylic acids and anhydrides thereof, which function as an end-stopping agent, and the like are preferred.

2) Polyamic Acid Ester

A diester dicarboxylic acid chloride may be obtained by reacting a tetracarboxylic dianhydride and an arbitrary alcohol to provide a diester dicarboxylic acid, and then reacting the diester dicarboxylic acid and a chlorinating agent (thionyl chloride, oxalyl chloride, and the like). The polyimide precursor may be obtained by stirring the diester dicarboxylic acid chloride and a diamine at a temperature of −20° C. to 120° C., preferably −5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced. The polyimide precursor may also be easily obtained by dehydrating/condensing a diester dicarboxylic acid and a diamine by the use of a phosphorus-based condensing agent, a carbodiimide condensing agent, or the like.

The polyimide precursor obtained by the method is stable, and therefore the polyimide precursor may be subjected to purification, including reprecipitation in which a solvent such as water and alcohols is added thereto.

3) Polyamic Acid Silyl Ester (Indirect Method)

A silylated diamine may be obtained by reacting a diamine and a silylating agent in advance. The silylated diamine may be purified by distillation, or the like, as necessary. And then, the polyimide precursor may be obtained by dissolving the silylated diamine in a dehydrated solvent, adding a tetracarboxylic dianhydride to the resulting solution gradually while stirring the solution, and then stirring the solution at a temperature of 0° C. to 120° C., preferably 5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced.

As for the silylating agent to be used herein, the use of a silylating agent containing no chlorine is preferred because it is unnecessary to purify the silylated diamine. Examples of the silylating agent containing no chlorine atom include N,O-bis(trimethylsilyl)trifluoroacetamide, N,O-bis(trimethylsilyl)acetamide, and hexamethyldisilazane. Among them, N,O-bis(trimethylsilyl)acetamide, and hexamethyldisilazane are particularly preferred, because they contain no fluorine atom and are inexpensive.

In addition, in the silylation reaction of diamine, an amine catalyst such as pyridine, piperidine and triethylamine may be used so as to accelerate the reaction. The catalyst may be used, as it is, as a catalyst for the polymerization of the polyimide precursor.

4) Polyamic Acid Silyl Ester (Direct Method)

The polyimide precursor may be obtained by mixing a polyamic acid solution obtained by the method 1) and a silylating agent, and then stirring the resulting mixture at a temperature of 0° C. to 120° C., preferably 5° C. to 80° C., for 1 hour to 72 hours. When they are reacted at a temperature of 80° C. or more, the molecular weight may vary depending on the temperature history in the polymerization and the imidization may proceed by heat, and therefore the polyimide precursor may not be stably produced.

As for the silylating agent to be used herein, the use of a silylating agent containing no chlorine is preferred because it is unnecessary to purify the silylated polyamic acid, or the obtained polyimide. Examples of the silylating agent containing no chlorine atom include N,O-bis(trimethylsilyl) trifluoroacetamide, N,O-bis(trimethylsilyl)acetamide, and hexamethyldisilazane. Among them, N,O-bis(trimethylsilyl)acetamide, and hexamethyldisilazane are particularly preferred, because they contain no fluorine atom and are inexpensive.

All of the production methods as described above may be suitably performed in an organic solvent, and as a consequence thereof, a solution or a solution composition comprising a polyimide precursor may be easily obtained.

As the solvent used in the production of the polyimide precursor, for example, aprotic solvents such as N,N-dimethylformamide, N,N-dimethylacetamide, N-methyl-2-pyrrolidone, 1,3-dimethyl-2-imidazolidinone and dimethyl sulfoxide are preferred, and N,N-dimethylacetamide is particularly preferred. However, any solvent may be used without any trouble on the condition that the starting monomer components and the formed polyimide precursor can be dissolved in the solvent, and the structure thereof is not limited thereto. Examples of the solvent preferably employed include amide solvents such as N,N-dimethylformamide, N,N-dimethylacetamide and N-methylpyrrolidone; cyclic ester solvents such as γ-butyrolactone, γ-valerolactone, δ-valerolactone, γ-caprolactone, ε-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. These solvents may be used in combination of a plurality of types.

The logarithmic viscosity of the polyimide precursor in a N,N-dimethylacetamide solution at a concentration of 0.5 g/dL at 30° C. may be preferably 0.2 dL/g or more, more preferably 0.3 dL/g or more, particularly preferably 0.4 dL/g or more, although the logarithmic viscosity of the polyimide precursor is not limited thereto. When the logarithmic viscosity is 0.2 dL/g or more, the molecular weight of the polyimide precursor is high, and therefore the obtained polyimide may have excellent mechanical strength and heat resistance.

The polyimide precursor composition of the second embodiment of the present invention comprises a polyimide precursor, and an imidazole compound and/or a trialkylamine compound, and may be prepared by adding an imidazole compound and/or a trialkylamine compound to a polyimide precursor solution or solution composition obtained by the production method as described above. As necessary, the solvent may be removed from or added to the polyimide precursor solution or solution composition, and a desired component other than the imidazole compound and the trialkylamine compound may be added thereto. Alternatively, the polyimide precursor composition of the second embodiment of the present invention (a solution composition comprising a polyimide precursor, and an imidazole compound and/or a trialkylamine compound) may be obtained by adding a tetracarboxylic acid component (a tetracarboxylic dianhydride, or the like), a diamine component, and an imidazole compound and/or a trialkylamine compound to a solvent, and then reacting the tetracarboxylic acid component and the diamine component in the presence of the imidazole compound and/or the trialkylamine compound.

The imidazole compound to be used in the present invention is not particularly limited, on the condition that it is a compound having an imidazole skeleton.

In one embodiment, a compound having a boiling point of less than 340° C., preferably 330° C. or less, more preferably 300° C. or less, particularly preferably 270° C. or less, at 1 atm may be preferably used as the imidazole compound.

Examples of the imidazole compound to be used in the present invention include, but not limited to, 1,2-dimethylimidazole, 1-methylimidazole, 2-methylimidazole, 2-phenylimidazole, imidazole, and benzoimidazole. Among them, 1,2-dimethylimidazole (boiling point at 1 atm: 205° C.), 1-methylimidazole (boiling point at 1 atm: 198° C.), 2-methylimidazole (boiling point at 1 atm: 268° C.), imidazole (boiling point at 1 atm: 256° C.), and the like are preferred, and 1,2-dimethylimidazole and 1-methylimidazole are particularly preferred. The imidazole compound may be used alone or in combination of a plurality of types.

The trialkylamine compound to be used in the present invention may be preferably, but not limited to, a compound having an alkyl group having 1 to 5 carbon atoms, more preferably having 1 to 4 carbon atoms, and examples thereof include trimethylamine, triethylamine, tri-n-propylamine, and tributylamine. The trialkylamine compound may be used alone or in combination of a plurality of types. In addition, one or more imidazole compounds and one or more trialkylamine compounds may be used in combination.

The amount of the imidazole compound and/or the trialkylamine compound in the polyimide precursor composition of the second embodiment of the present invention is preferably less than 4 mol relative to 1 mol of the repeating unit of the polyimide precursor. When the amount of the imidazole compound and/or the trialkylamine compound is 4 mol or more relative to 1 mol of the repeating unit of the polyimide precursor, the storage stability of the polyimide precursor composition may be reduced. The amount of the imidazole compound and/or the trialkylamine compound is preferably 0.05 mol or more relative to 1 mol of the repeating unit of the polyimide precursor, and is more preferably 2 mol or less, particularly preferably 1 mol or less, relative to 1 mol of the repeating unit of the polyimide precursor. Herein, 1 mol of the repeating unit of the polyimide precursor corresponds to 1 mol of the tetracarboxylic acid component.

The polyimide precursor composition of the second embodiment of the present invention usually comprises a solvent. As the solvent used for the polyimide precursor composition of the second embodiment of the present invention, any solvent may be used without any trouble on the condition that the polyimide precursor can be dissolved in the solvent, and the structure thereof is not particularly limited. Examples of the solvent preferably employed include amide solvents such as N,N-dimethylformamide, N,N-dimethylacetamide and N-methyl-2-pyrrolidone; cyclic ester solvents such as γ-butyrolactone, γ-valerolactone, δ-valerolactone, γ-caprolactone, e-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. Additionally, these may be used in combination of a plurality of types. The solvent used in the preparation of the polyimide precursor itself may be used as the solvent of the polyimide precursor composition.

In the polyimide precursor composition of the second embodiment of the present invention, it is preferred that the total amount of the tetracarboxylic acid component and the diamine component is 5 mass % or more, preferably 10 mass % or more, more preferably 15 mass % or more, relative to the total amount of the solvent, the tetracarboxylic acid component and the diamine component. Additionally, it is generally preferred that the total amount of the tetracarboxylic acid component and the diamine component is 60 mass % or less, preferably 50 mass % or less, relative to the total amount of the solvent, the tetracarboxylic acid component and the diamine component. When the concentration, which is approximate to the concentration of the solid content based on the polyimide precursor, is too low, it may be difficult to control the thickness of the obtained polyimide film in the production of the polyimide film, for example.

Although the viscosity (rotational viscosity) of the polyimide precursor composition is not limited thereto, the rotational viscosity, which is measured with an E-type rotational viscometer at a temperature of 25° C. and at a shearing speed of 20 sec⁻¹, may be preferably 0.01 to 1000 Pa-sec, more preferably 0.1 to 100 Pa-sec. In addition, thixotropy may be imparted, as necessary. When the viscosity is within the above-mentioned range, the composition is easy to handle during the coating or the film formation, and the composition is less repelled and has excellent leveling property, and therefore a good film may be obtained.

The polyimide precursor composition of the second embodiment of the present invention may comprise a chemical imidizing agent (an acid anhydride such as acetic anhydride, and an amine compound such as pyridine and isoquinoline), an anti-oxidizing agent, a filler (including an inorganic particle such as silica), a dye, a pigment, a coupling agent such as a silane coupling agent, a primer, a flame retardant, a defoaming agent, a leveling agent, a rheology control agent (flow-promoting agent), a releasing agent, and the like, as necessary.

The polyimide of the second embodiment of the present invention may be obtained by imidizing the polyimide precursor composition of the second embodiment of the present invention as described above (i.e., subjecting the polyimide precursor to the dehydration/ring closure reaction). The imidization method is not particularly limited, and any known thermal imidization or chemical imidization method may be suitably applied. Preferred examples of the form of the obtained polyimide include a film, a laminate of a polyimide film and another substrate, a coating film, a powder, a bead, a molded article, and a foamed article. One concrete example of the method for producing the polyimide of the second embodiment of the present invention will be described later in <Method for producing a polyimide film/base laminate, or a polyimide film and Substrate>.

The polyimide of the second embodiment of the present invention is the one obtained using the tetracarboxylic acid component and the diamine component used to obtain the polyimide precursor of the second embodiment of the present invention as described above, and the preferred tetracarboxylic acid component and the preferred diamine component are also the same as in the polyimide precursor of the second embodiment of the present invention as described above.

The thickness of the film formed of the polyimide obtained from the polyimide precursor composition of the second embodiment of the present invention (the polyimide of the second embodiment of the present invention) is generally preferably 5 m to 200 m, more preferably 10 m to 150 m, although it varies depending on the intended use. When the polyimide film is too thick, the light transmittance may be low in the case where the polyimide film is used in applications where light passes through the polyimide film, including in display application. When the polyimide film is too thin, the load at break, and the like, may be reduced and the polyimide film may not be suitably used as a film.

It is desirable that a polyimide film has higher transparency when the polyimide film is used in applications where light passes through the polyimide film, including in display application, in particular. The polyimide obtained from the polyimide precursor composition of the second embodiment of the present invention (the polyimide of the second embodiment of the present invention) may have preferably, but not limited to, a YI (yellowness index) of 4 or less, more preferably 3.5 or less, more preferably 3 or less, more preferably 2.8 or less, particularly preferably 2.5 or less, when the polyimide is formed into a film.

The polyimide obtained from the polyimide precursor composition of the second embodiment of the present invention (the polyimide of the second embodiment of the present invention) may have preferably, but not limited to, a haze of 3% or less, more preferably 2% or less, more preferably 1.5% or less, particularly preferably less than 1%, when the polyimide is formed into a film. In the case where the polyimide film is used in display application, for example, the light may be scattered and the image may be blurred when the haze is as high as more than 3%.

The polyimide obtained from the polyimide precursor composition of the second embodiment of the present invention (the polyimide of the second embodiment of the present invention) may have preferably, but not limited to, a light transmittance at 400 nm of 75% or more, more preferably 78% or more, more preferably 80% or more, particularly preferably more than 80%, when the polyimide is formed into a film. When the light transmittance is low, the light source must be bright, and therefore a problem of more energy required, or the like may arise in the case where the polyimide is used in display application, or the like.

Mechanical properties are usually also required for a polyimide film. The polyimide obtained from the polyimide precursor composition of the second embodiment of the present invention (the polyimide of the second embodiment of the present invention) may have preferably, but not limited to, a tensile modulus of elasticity of 4 GPa or more, more preferably 4.5 GPa or more, more preferably 5 GPa or more, more preferably 5.3 GPa or more, more preferably 5.5 GPa or more, particularly preferably 5.8 GPa or more, when the polyimide is formed into a film.

The polyimide obtained from the polyimide precursor composition of the second embodiment of the present invention (the polyimide of the second embodiment of the present invention) may have preferably, but not limited to, a load at break of 10 N or more, more preferably 15 N or more, when the polyimide is formed into a film.

The polyimide obtained from the polyimide precursor composition of the second embodiment of the present invention (the polyimide of the second embodiment of the present invention) may have preferably, but not limited to, an elongation at break of 2.5% or more, more preferably 3% or more, when the polyimide is formed into a film.

The polyimide obtained from the polyimide precursor composition of the second embodiment of the present invention (the polyimide of the second embodiment of the present invention) may have preferably, but not limited to, a coefficient of linear thermal expansion from 100° C. to 250° C. of 45 ppm/K or less, more preferably 40 ppm/K or less, more preferably 35 ppm/K or less, particularly preferably 30 ppm/K or less, when the polyimide is formed into a film. When the coefficient of linear thermal expansion is great, the difference in coefficient of linear thermal expansion between the polyimide and a conductive material such as a metal is great, and therefore a trouble such as an increase in warpage may occur during the formation of a circuit board, for example.

The polyimide obtained from the polyimide precursor composition of the second embodiment of the present invention (the polyimide of the second embodiment of the present invention) may have preferably, but not limited to, a 5% weight loss temperature, which is the index of the heat resistance of the polyimide film, of 375° C. or more, more preferably 380° C. or more, more preferably 400° C. or more, particularly preferably 420° C. or more. In the case where a gas barrier film, or the like is formed on the polyimide for the formation of a transistor on the polyimide, or the like, swelling may occur between the polyimide and the barrier film due to outgassing associated with the decomposition of the polyimide when the heat resistance is low.

The polyimide obtained from the polyimide precursor composition of the second embodiment of the present invention (the polyimide of the second embodiment of the present invention) has high transparency and excellent mechanical properties such as a tensile modulus of elasticity and a load at break, and has a low coefficient of linear thermal expansion and excellent heat resistance, and therefore may be suitably used, for example, in the application of cover sheet (protective film) for display screen, and in the applications of transparent substrate for display, transparent substrate for touch panel, or substrate for solar battery.

### <Polyimide Precursor and Polyimide of the Third Embodiment of the Present Invention>

The polyimide precursor of the third embodiment of the present invention comprises a repeating unit represented by the chemical formula (1A) and a repeating unit represented by the chemical formula (2A) in an amount of 50 mol % or more relative to the total repeating units. The polyimide precursor of the third embodiment of the present invention, however, may comprise a repeating unit represented by the chemical formula (1A) and a repeating unit represented by the chemical formula (2A) in an amount of 50 mol % or more relative to the total repeating units as a whole, and may comprise a polyimide precursor comprising only a repeating unit represented by the chemical formula (1A) and a polyimide precursor comprising only a repeating unit represented by the chemical formula (2A).

The polyimide of the third embodiment of the present invention is the one comprising a repeating unit represented by the chemical formula (1) and a repeating unit represented by the chemical formula (2) in an amount of 50 mol % or more relative to the total repeating units. In other words, the polyimide of the third embodiment of the present invention is the one obtained from the polyimide precursor of the third embodiment of the present invention, and more specifically, obtained by heating a polyimide precursor composition comprising the polyimide precursor of the third embodiment of the present invention.

The polyimide precursor of the third embodiment of the present invention and the polyimide of the third embodiment of the present invention, however, is not limited to the ones from which the polyimide film of the first embodiment of the present invention may be obtained.

As for the polyimide precursor of the third embodiment of the present invention, it is preferred that the amount of the repeating unit represented by the chemical formula (1A) is 10 mol % to 90 mol % relative to the total repeating units, and the amount of the repeating unit represented by the chemical formula (2A) is 10 mol % to 90 mol % relative to the total repeating units, and it is more preferred that the amount of the repeating unit represented by the chemical formula (1A) is 30 mol % to 90 mol % relative to the total repeating units, and the amount of the repeating unit represented by the chemical formula (2A) is 10 mol % to 70 mol % relative to the total repeating units, and it is particularly preferred that the amount of the repeating unit represented by the chemical formula (1A) is 50 mol % to 90 mol % relative to the total repeating units, and the amount of the repeating unit represented by the chemical formula (2A) is 10 mol % to 50 mol % relative to the total repeating units.

The total amount of the repeating unit represented by the chemical formula (1A) and the repeating unit represented by the chemical formula (2A) is 50 mol % or more, and preferably 70 mol % to 100 mol %, more preferably 80 mol % to 100 mol %, particularly preferably 90 mol % to 100 mol %, relative to the total repeating units.

In addition, it is preferred that the polyimide precursor of the third embodiment of the present invention comprises a repeating unit represented by the chemical formula (3A) and a repeating unit represented by the chemical formula (4A), including a repeating unit represented by the chemical formula (1A) [a repeating unit represented by the chemical formula (3A) in which A₁ is a group represented by the chemical formula (D-1)], and a repeating unit represented by the chemical formula (2A) [a repeating unit represented by the chemical formula (4A) in which A₂ is a group represented by the chemical formula (D-1)], preferably in an amount of 90 mol % or more, more preferably 95 mol % or more, relative to the total repeating units. In one embodiment, it is particularly preferred that the polyimide precursor of the third embodiment of the present invention consists of a repeating unit represented by the chemical formula (3A) and a repeating unit represented by the chemical formula (4A) [including a repeating unit represented by the chemical formula (1A) and a repeating unit represented by the chemical formula (2A)].

The polyimide precursor may comprise one type of repeating unit represented by the chemical formula (3A), or comprise at least two types of repeating units represented by the chemical formula (3A) in which A₁ is different, and may comprise one type of repeating unit represented by the chemical formula (4A), or comprise at least two types of repeating units represented by the chemical formula (4A) in which A₂ is different.

As the A₁ in the chemical formula (3A) and the A₂ in the chemical formula (4A) other than the group represented by the chemical formula (D-1), a divalent group having an aromatic ring which has 6 to 40 carbon atoms is preferred, and a group represented by the following chemical formula (A-1) is particularly preferred.

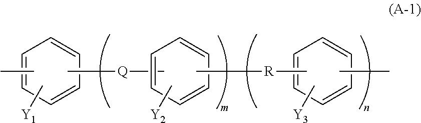

wherein m independently represents 0 to 3 and n independently represents 0 to 3; Y₁, Y₂ and Y₃ each independently represent one selected from the group consisting of hydrogen atom, methyl group and trifluoromethyl group; and Q and R each independently represent direct bond, or one selected from the group consisting of groups represented by the formulas: —NHCO—, —CONH—, —COO— and —OCO—.

The tetracarboxylic acid component to provide a repeating unit represented by the chemical formula (1A) and a repeating unit represented by the chemical formula (3A) is 1,2,3,4-cyclobutane tetracarboxylic acid, or the like (The term “tetracarboxylic acid, or the like” means tetracarboxylic acid, and tetracarboxylic acid derivatives including tetracarboxylic dianhydride, tetracarboxylic acid silyl ester, tetracarboxylic acid ester and tetracarboxylic acid chloride). The tetracarboxylic acid component to provide a repeating unit represented by the chemical formula (2A) and a repeating unit represented by the chemical formula (4A) is norbornane-2-spiro-α-cyclopentanone-α′-spiro-2″-norbornane-5,5″,6,6″-tetracarboxylic acid, or the like. The diamine component to provide a repeating unit represented by the chemical formula (1A) [a repeating unit represented by the chemical formula (3A) in which A₁ is a group represented by the chemical formula (D-1)] and a repeating unit represented by the chemical formula (2A) [a repeating unit represented by the chemical formula (4A) in which A₂ is a group represented by the chemical formula (D-1)] is 2,2′-dimethyl-4,4′-diaminobiphenyl (m-tolidine).

In other words, the polyimide precursor of the third embodiment of the present invention is a polyimide precursor obtained from

a tetracarboxylic acid component comprising 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like; and

a diamine component comprising 2,2′-dimethyl-4,4′-diaminobiphenyl (m-tolidine),

with the proviso that the amount of 1,2,3,4-cyclobutane tetracarboxylic acid, or the like, and norbornane-2-spiro-α-cyclopentanone-α′-spiro-2″-norbornane-5,5″,6,6″-tetracarboxylic acid, or the like in the tetracarboxylic acid component, and the amount of 2,2′-dimethyl-4,4′-diaminobiphenyl in the diamine component are selected such that the total amount of the repeating unit represented by the chemical formula (1A) and the repeating unit represented by the chemical formula (2A) in the obtained polyimide precursor is 50 mol % or more relative to the total repeating units.

As the tetracarboxylic acid component to provide a repeating unit represented by the chemical formula (1A) [a repeating unit represented by the chemical formula (3A) in which A₁ is a group represented by the chemical formula (D-1)] and a repeating unit represented by the chemical formula (3A), 1,2,3,4-cyclobutane tetracarboxylic acid, or the like may be used alone or in combination of a plurality of types. As the tetracarboxylic acid component to provide a repeating unit represented by the chemical formula (2A) [a repeating unit represented by the chemical formula (4A) in which A₂ is a group represented by the chemical formula (D-1)] and a repeating unit represented by the chemical formula (4A), norbornane-2-spiro-α-cyclopentanone-α′-spiro-2″-norbornane-5,5″,6,6″-tetracarboxylic acid, or the like may be used alone or in combination of a plurality of types. As for norbornane-2-spiro-α-cyclopentanone-α′-spiro-2″-norbornane-5,5″,6,6″-tetracarboxylic acid, or the like, trans-endo-endo-norbornane-2-spiro-α-cyclopentanone-α′-spiro-2″-norbornane-5,5″,6,6″-tetracarboxylic acid, or the like and/or cis-endo-endo-norbornane-2-spiro-α-cyclopentanone-α′-spiro-2″-norbornane-5,5″,6,6″-tetracarboxylic acid, or the like are more preferred.

The diamine component to provide a repeating unit of the chemical formula (3A) or the chemical formula (4A) other than a repeating unit represented by the chemical formula (1A) and a repeating unit represented by the chemical formula (2A), that is, having a group other than a group represented by the chemical formula (D-1) as A₁ or A₂ is a diamine having an aromatic ring (aromatic diamine), and preferably comprises a diamine to provide a repeating unit of the chemical formula (3A) in which A₁ is a group represented by the chemical formula (A-1) and a repeating unit of the chemical formula (4A) in which A₂ is a group represented by the chemical formula (A-1).

The diamine component to provide a repeating unit of the chemical formula (3A) in which A₁ is a group represented by the chemical formula (A-1) and a repeating unit of the chemical formula (4A) in which A₂ is a group represented by the chemical formula (A-1) has an aromatic ring, and when the diamine component has a plurality of aromatic rings, the aromatic rings are independently linked to each other by direct bond, amide bond, or ester bond. When the aromatic rings are linked at the 4-position relative to the amino group or the linking group between the aromatic rings, the obtained polyimide has a linear structure and may have low linear thermal expansibility, although the linking position of the aromatic rings is not limited thereto. Meanwhile, the aromatic ring may be substituted by methyl or trifluoromethyl. The substitution position is not particularly limited.

Examples of the diamine component to provide a repeating unit of the chemical formula (3A) in which A₁ is a group represented by the chemical formula (A-1) and a repeating unit of the chemical formula (4A) in which A₂ is a group represented by the chemical formula (A-1) include, but not limited to, p-phenylenediamine, m-phenylenediamine, benzidine, 3,3′-diamino-biphenyl, 2,2′-bis(trifluoromethyl)benzidine, 3,3′-bis(trifluoromethyl) benzidine, 4,4′-diaminobenzanilide, 3,4′-diaminobenzanilide, N,N′-bis(4-aminophenyl)terephthalamide, N,N′-p-phenylene bis(p-aminobenzamide), 4-aminophenoxy-4-diaminobenzoate, bis(4-aminophenyl)terephthalate, biphenyl-4,4′-dicarboxylic acid bis(4-aminophenyl) ester, p-phenylene bis(p-aminobenzoate), bis(4-aminophenyl)-[1,1′-biphenyl]-4,4′-dicarboxylate, and [1,1′-biphenyl]-4,4′-diyl bis(4-aminobenzoate). The diamine component may be used alone or in combination of a plurality of types. Among them, p-phenylenediamine, o-tolidine, 4,4′-diaminobenzanilide, 4-aminophenoxy-4-diaminobenzoate, 2,2′-bis(trifluoromethyl)benzidine, benzidine, N,N′-bis(4-aminophenyl)terephthalamide, and biphenyl-4,4′-dicarboxylic acid bis(4-aminophenyl)ester are preferred, and p-phenylenediamine, 4,4′-diaminobenzanilide, and 2,2′-bis(trifluoromethyl)benzidine are more preferred. These diamines may be used alone or in combination of a plurality of types.

As the diamine component to provide a repeating unit of the chemical formula (3A) or the chemical formula (4A), other aromatic diamines other than the diamine component which provides the one in which A₁ or A₂ is a structure of the chemical formula (D-1) or the chemical formula (A-1) may be used. Examples of the other diamine component include 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis(4-(4-aminophenoxy)phenyl) hexafluoropropane, 2,2-bis(4-aminophenyl)hexafluoropropane, bis(4-aminophenyl)sulfone, 3,3′-bis(trifluoromethyl)benzidine, 3,3′-bis((aminophenoxy)phenyl)propane, 2, 2′-bis(3-amino-4-hydroxyphenyl) hexafluoropropane, bis(4-(4-aminophenoxy)diphenyl) sulfone, bis(4-(3-aminophenoxy)diphenyl) sulfone, octafluorobenzidine, 3,3′-dimethoxy-4,4′-diaminobiphenyl, 3,3′-dichloro-4,4′-diaminobiphenyl, 3,3′-difluoro-4,4′-diaminobiphenyl, 6,6′-bis(3-aminophenoxy)-3,3,3′,3′-tetramethyl-1,1′-spirobiindane, and 6,6′-bis(4-aminophenoxy)-3,3,3′,3′-tetramethyl-1,1′-spirobiindane, and derivatives thereof. These may be used alone or in combination of a plurality of types. Among them, 4,4′-oxydianiline, 3,4′-oxydianiline, 3,3′-oxydianiline, p-methylene bis(phenylenediamine), 1,3-bis(4-aminophenoxy)benzene, 1,3-bis(3-aminophenoxy)benzene, 1,4-bis(4-aminophenoxy)benzene, 4,4′-bis(4-aminophenoxy)biphenyl, and 4,4′-bis(3-aminophenoxy)biphenyl are preferred, and 4,4′-oxydianiline, and 4,4′-bis(4-aminophenoxy)biphenyl are particularly preferred.

In one embodiment, in view of the properties of the obtained polyimide, the ratio of the diamine component to provide a structure of the chemical formula (A-1) may be preferably, for example, 65 mol % or less, preferably 75 mol % or less, more preferably 80 mol % or less, particularly preferably 90 mol % or less, in total, relative to 100 mol % of the diamine component to provide a repeating unit of the chemical formula (3A) or the chemical formula (4A). For example, other diamines such as a diamine having an ether bond (—O—), including 4,4′-oxydianiline and 4,4′-bis(4-aminophenoxy)biphenyl, may be preferably used, for example, in an amount of 35 mol % or less, preferably 25 mol % or less, more preferably 20 mol % or less, particularly preferably 10 mol % or less, relative to 100 mol % of the diamine component to provide a repeating unit of the chemical formula (3A) or the chemical formula (4A).

The polyimide precursor of the third embodiment of the present invention may comprise one or more of other repeating units other than the repeating units represented by the chemical formula (1A), the chemical formula (2A), the chemical formula (3A), or the chemical formula (4A).

Other aromatic or aliphatic tetracarboxylic acids, or the like may be used as the tetracarboxylic acid component to provide the other repeating unit. Examples thereof include those described above as the tetracarboxylic acid component to provide the other repeating unit in the polyimide of the first embodiment of the present invention. These may be used alone or in combination of a plurality of types.

Additionally, in the case where the diamine component to be combined therewith is an aliphatic diamine, derivatives of, and dianhydrides of 1,2,3,4-cyclobutane tetracarboxylic acid, or the like and norbornane-2-spiro-α-cyclopentanone-α′-spiro-2″-norbornane-5,5″,6,6″-tetracarboxylic acid, or the like may also be used as the tetracarboxylic acid component to provide the other repeating unit.

The diamine component to provide the other repeating unit may be the diamine described as the diamine component to provide a repeating unit of the chemical formula (3A) in which A₁ is a group represented by the chemical formula (A-1) and a repeating unit of the chemical formula (4A) in which A₂ is a group represented by the chemical formula (A-1), that is, 2,2′-dimethyl-4,4′-diaminobiphenyl.

Other aromatic or aliphatic diamines may be used as the diamine component to provide the other repeating unit. Examples thereof include those described above as the diamine component to provide the other repeating unit in the polyimide of the first embodiment of the present invention. These may be used alone or in combination of a plurality of types.

In the polyimide precursor of the third embodiment of the present invention, R₁ and R₂ in the chemical formula (1A), R₃ and R₄ in the chemical formula (2A), R₅ and R₆ in the chemical formula (3A), and R₇ and R₈ in the chemical formula (4A) are each independently hydrogen, an alkyl group having 1 to 6 carbon atoms, preferably having 1 to 3 carbon atoms (more preferably methyl or ethyl), or an alkylsilyl group having 3 to 9 carbon atoms (more preferably trimethylsilyl or t-butyldimethylsilyl).

When an alkyl group or an alkylsilyl group is introduced, R₁ and R₂, R₃ and R₄, R₅ and R₆, and R₇ and R₈ each may be converted into an alkyl group or an alkylsilyl group in a ratio of 25% or more, preferably 50% or more, more preferably 75% or more, although the introduction ratio of the functional groups is not limited thereto.

According to the chemical structures which R₁ and R₂, R₃ and R₄, R₅ and R₆, and R₇ and R₈ have, the polyimide precursors of the third embodiment of the present invention may also be classified into

1) polyamic acid (R₁ and R₂, R₃ and R₄, R₅ and R₆, and R₇ and R₈ are hydrogen),

2) polyamic acid ester (at least part of R₁ and R₂, R₃ and R₄, R₅ and R₆, and R₇ and R₈ is alkyl group), and

3) 4) polyamic acid silyl ester (at least part of R₁ and R₂, R₃ and R₄, R₅ and R₆, and R₇ and R₈ is alkylsilyl group).

Each class of the polyimide precursors of the third embodiment of the present invention may also be easily produced by the same methods as the methods for producing the polyimide precursor of the second embodiment of the present invention as described in Section <Polyimide precursor composition and Polyimide of the second embodiment of the present invention>. However, the method for producing the polyimide precursor of the third embodiment of the present invention is not limited to these production methods.

As for the solvent used in the production of the polyimide precursor, the same solvent as used in the method for producing the polyimide precursor of the second embodiment of the present invention may be used.

The logarithmic viscosity of the polyimide precursor in a N,N-dimethylacetamide solution at a concentration of 0.5 g/dL at 30° C. may be preferably 0.2 dL/g or more, more preferably 0.3 dL/g or more, particularly preferably 0.4 dL/g or more, although the logarithmic viscosity of the polyimide precursor is not limited thereto. When the logarithmic viscosity is 0.2 dL/g or more, the molecular weight of the polyimide precursor is high, and therefore the obtained polyimide may have excellent mechanical strength and heat resistance.

The polyimide precursor composition of the third embodiment of the present invention usually comprises a polyimide precursor, and a solvent. As the solvent used for the polyimide precursor composition of the third embodiment of the present invention, any solvent may be used without any trouble on the condition that the polyimide precursor can be dissolved in the solvent, and the structure thereof is not particularly limited. Examples of the solvent preferably employed include amide solvents such as N,N-dimethylformamide, N,N-dimethylacetamide and N-methyl-2-pyrrolidone; cyclic ester solvents such as γ-butyrolactone, γ-valerolactone, δ-valerolactone, γ-caprolactone, ε-caprolactone and α-methyl-γ-butyrolactone; carbonate solvents such as ethylene carbonate and propylene carbonate; glycol solvents such as triethylene glycol; phenol solvents such as m-cresol, p-cresol, 3-chlorophenol and 4-chlorophenol; acetophenone, 1,3-dimethyl-2-imidazolidinone, sulfolane, and dimethylsulfoxide. In addition, other common organic solvents, namely, phenol, o-cresol, butyl acetate, ethyl acetate, isobutyl acetate, propyleneglycol methyl acetate, ethyl cellosolve, butyl cellosolve, 2-methyl cellosolve acetate, ethyl cellosolve acetate, butyl cellosolve acetate, tetrahydrofuran, dimethoxyethane, diethoxyethane, dibutyl ether, diethylene glycol dimethyl ether, methyl isobutyl ketone, diisobutyl ketone, cyclopentanone, cyclohexanone, methyl ethyl ketone, acetone, butanol, ethanol, xylene, toluene, chlorobenzene, turpentine, mineral spirits, petroleum naphtha-based solvents, and the like may be used. Additionally, these may be used in combination of a plurality of types. The solvent used in the preparation of the polyimide precursor itself may be used as the solvent of the polyimide precursor composition.

In the polyimide precursor composition of the third embodiment of the present invention, it is preferred that the total amount of the tetracarboxylic acid component and the diamine component is 5 mass % or more, preferably 10 mass % or more, more preferably 15 mass % or more, relative to the total amount of the solvent, the tetracarboxylic acid component and the diamine component. Additionally, it is generally preferred that the total amount of the tetracarboxylic acid component and the diamine component is 60 mass % or less, preferably 50 mass % or less, relative to the total amount of the solvent, the tetracarboxylic acid component and the diamine component. When the concentration, which is approximate to the concentration of the solid content based on the polyimide precursor, is too low, it may be difficult to control the thickness of the obtained polyimide film in the production of the polyimide film, for example.

Although the viscosity (rotational viscosity) of the polyimide precursor composition is not limited thereto, the rotational viscosity, which is measured with an E-type rotational viscometer at a temperature of 25° C. and at a shearing speed of 20 sec⁻¹, may be preferably 0.01 to 1000 Pa-sec, more preferably 0.1 to 100 Pa-sec. In addition, thixotropy may be imparted, as necessary. When the viscosity is within the above-mentioned range, the composition is easy to handle during the coating or the film formation, and the composition is less repelled and has excellent leveling property, and therefore a good film may be obtained.

The polyimide precursor composition of the third embodiment of the present invention may comprise a chemical imidizing agent (an acid anhydride such as acetic anhydride, and an amine compound such as pyridine and isoquinoline), an anti-oxidizing agent, a filler (including an inorganic particle such as silica), a dye, a pigment, a coupling agent such as a silane coupling agent, a primer, a flame retardant, a defoaming agent, a leveling agent, a rheology control agent (flow-promoting agent), a releasing agent, and the like, as necessary.

The polyimide of the third embodiment of the present invention may be obtained by imidizing the polyimide precursor of the third embodiment of the present invention as described above (i.e., subjecting the polyimide precursor to the dehydration/ring closure reaction). The imidization method is not particularly limited, and any known thermal imidization or chemical imidization method may be suitably applied. Preferred examples of the form of the obtained polyimide include a film, a laminate of a polyimide film and another substrate, a coating film, a powder, a bead, a molded article, and a foamed article. One concrete example of the method for producing the polyimide of the third embodiment of the present invention will be described later in <Method for producing a polyimide film/base laminate, or a polyimide film and Substrate>.

The polyimide of the third embodiment of the present invention is the one obtained using the tetracarboxylic acid component and the diamine component used to obtain the polyimide precursor of the third embodiment of the present invention as described above, and the preferred tetracarboxylic acid component and the preferred diamine component are also the same as in the polyimide precursor of the third embodiment of the present invention as described above.

The thickness of the film formed of the polyimide obtained from the polyimide precursor of the third embodiment of the present invention (the polyimide of the third embodiment of the present invention) is generally preferably 5 μm to 200 μm, more preferably 10 μm to 150 μm, although it varies depending on the intended use. When the polyimide film is too thick, the light transmittance may be low in the case where the polyimide film is used in applications where light passes through the polyimide film, including in display application. When the polyimide film is too thin, the load at break, and the like, may be reduced and the polyimide film may not be suitably used as a film.

It is desirable that a polyimide film has higher transparency when the polyimide film is used in applications where light passes through the polyimide film, including in display application, in particular. The polyimide obtained from the polyimide precursor of the third embodiment of the present invention (the polyimide of the third embodiment of the present invention) may have preferably, but not limited to, a YI (yellowness index) of 4 or less, more preferably 3.5 or less, more preferably 3 or less, more preferably 2.8 or less, particularly preferably 2.5 or less, when the polyimide is formed into a film.

The polyimide obtained from the polyimide precursor of the third embodiment of the present invention (the polyimide of the third embodiment of the present invention) may have preferably, but not limited to, a haze of 3% or less, more preferably 2% or less, more preferably 1.5% or less, particularly preferably less than 1%, when the polyimide is formed into a film. In the case where the polyimide film is used in display application, for example, the light may be scattered and the image may be blurred when the haze is as high as more than 3%.

The polyimide obtained from the polyimide precursor of the third embodiment of the present invention (the polyimide of the third embodiment of the present invention) may have preferably, but not limited to, a light transmittance at 400 nm of 75% or more, more preferably 78% or more, more preferably 80% or more, particularly preferably more than 80%, when the polyimide is formed into a film. When the light transmittance is low, the light source must be bright, and therefore a problem of more energy required, or the like may arise in the case where the polyimide is used in display application, or the like.

Mechanical properties are usually also required for a polyimide film. The polyimide obtained from the polyimide precursor of the third embodiment of the present invention (the polyimide of the third embodiment of the present invention) may have preferably, but not limited to, a tensile modulus of elasticity of 4 GPa or more, more preferably 4.5 GPa or more, more preferably 5 GPa or more, more preferably 5.3 GPa or more, more preferably 5.5 GPa or more, particularly preferably 5.8 GPa or more, when the polyimide is formed into a film.

The polyimide obtained from the polyimide precursor of the third embodiment of the present invention (the polyimide of the third embodiment of the present invention) may have preferably, but not limited to, a load at break of 10 N or more, more preferably 15 N or more, when the polyimide is formed into a film.

The polyimide obtained from the polyimide precursor of the third embodiment of the present invention (the polyimide of the third embodiment of the present invention) may have preferably, but not limited to, an elongation at break of 2.5% or more, more preferably 3% or more, when the polyimide is formed into a film.

The polyimide obtained from the polyimide precursor of the third embodiment of the present invention (the polyimide of the third embodiment of the present invention) may have preferably, but not limited to, a coefficient of linear thermal expansion from 100° C. to 250° C. of 45 ppm/K or less, more preferably 40 ppm/K or less, more preferably 35 ppm/K or less, particularly preferably 30 ppm/K or less, when the polyimide is formed into a film. When the coefficient of linear thermal expansion is great, the difference in coefficient of linear thermal expansion between the polyimide and a conductive material such as a metal is great, and therefore a trouble such as an increase in warpage may occur during the formation of a circuit board, for example.

The polyimide obtained from the polyimide precursor of the third embodiment of the present invention (the polyimide of the third embodiment of the present invention) may have preferably, but not limited to, a 5% weight loss temperature, which is the index of the heat resistance of the polyimide film, of 375° C. or more, more preferably 380° C. or more, more preferably 400° C. or more, particularly preferably 420° C. or more. In the case where a gas barrier film, or the like is formed on the polyimide for the formation of a transistor on the polyimide, or the like, swelling may occur between the polyimide and the barrier film due to outgassing associated with the decomposition of the polyimide when the heat resistance is low.

The polyimide obtained from the polyimide precursor of the third embodiment of the present invention (the polyimide of the third embodiment of the present invention) has high transparency and excellent mechanical properties such as a tensile modulus of elasticity and a load at break, and has a low coefficient of linear thermal expansion and excellent heat resistance, and therefore may be suitably used, for example, in the application of cover sheet (protective film) for display screen, and in the applications of transparent substrate for display, transparent substrate for touch panel, or substrate for solar battery.

### <Method for Producing a Polyimide Film/Base Laminate, or a Polyimide Film and Substrate>

One example of a method for producing a polyimide film/base laminate, or a polyimide film with the use of the polyimide precursor composition of the second embodiment of the present invention, or the polyimide precursor of the third embodiment of the present invention will be described below. However, the method is not limited to the method as described below.

The polyimide precursor composition of the second embodiment of the present invention (varnish), or a composition comprising the polyimide precursor of the third embodiment of the present invention (varnish) is flow-cast on a base, for example, made of ceramic (glass, silicon, alumina, or the like), metal (copper, aluminum, stainless steel, or the like), heat-resistant plastic film (polyimide film, or the like), or the like, and dried at a temperature of 20° C. to 180° C., preferably 20° C. to 150° C., by the use of hot air or infrared ray in a vacuum, in an inert gas such as nitrogen, or in air. Herein, the polyimide precursor composition of the second embodiment of the present invention comprises an imidazole compound and/or a trialkylamine compound, whereas the composition comprising the polyimide precursor of the third embodiment of the present invention may not comprise an imidazole compound and a trialkylamine compound. And then, the obtained polyimide precursor film is heated and imidized, for example, at a temperature of 200° C. to 500° C., more preferably about 250° C. to about 450° C., by the use of hot air or infrared ray in a vacuum, in an inert gas such as nitrogen, or in air, wherein the polyimide precursor film is on the base, or alternatively, the polyimide precursor film is peeled from the base and fixed at the film edges, to provide a polyimide film/base laminate, or a polyimide film. The thermal imidization is preferably performed in a vacuum or in an inert gas so as to prevent oxidation and degradation of the obtained polyimide film. The thermal imidization may be performed in air if the thermal imidization temperature is not too high.

The imidization reaction of the polyimide precursor may also be performed by chemical treatment in which the polyimide precursor is immersed in a solution containing a dehydrating/cyclizing agent such as acetic anhydride in the presence of a tertiary amine such as pyridine and triethylamine, instead of the thermal imidization by heat treatment as described above. Alternatively, a partially-imidized polyimide precursor may be prepared by adding the dehydrating/cyclizing agent to the polyimide precursor composition (varnish) in advance and stirring the varnish, and then flow-casting the varnish on a base and drying it. A polyimide film/base laminate, or a polyimide film may be obtained by further subjecting the obtained partially-imidized polyimide precursor film to heat treatment as described above, wherein the polyimide precursor film is on the base, or alternatively, the polyimide precursor film is peeled from the base and fixed at the film edges.

As described above, the polyimide film or the polyimide film/base laminate thus obtained may be suitably used for a cover sheet (cover film) for a display, and may also be suitably used for a substrate for a display, a touch panel, a solar battery, or the like. As an example thereof, a substrate comprising the polyimide film of the present invention will be described below.

A flexible conductive substrate may be obtained by forming a conductive layer on one surface or both surfaces of the polyimide film/base laminate or the polyimide film obtained as described above.

A flexible conductive substrate may be obtained by the following methods, for example. As for the first method, the polyimide film is not peeled from the base in the polyimide film/base laminate, and a conductive layer of a conductive material (metal or metal oxide, conductive organic material, conductive carbon, or the like) is formed on the surface of the polyimide film by sputtering, vapor deposition, printing, or the like, to provide a conductive laminate which is a conductive layer/polyimide film/base laminate. And then, as necessary, the conductive layer/polyimide film laminate is peeled from the base, to provide a transparent and flexible conductive substrate which consists of a conductive layer/polyimide film laminate.

As for the second method, the polyimide film is peeled from the base in the polyimide film/base laminate to obtain the polyimide film, and then a conductive layer of a conductive material (metal or metal oxide, conductive organic material, conductive carbon, or the like) is formed on the surface of the polyimide film in the same way as in the first method, to provide a transparent and flexible conductive substrate which consists of a conductive layer/polyimide film laminate, or a conductive layer/polyimide film laminate/conductive layer.

In the first and the second methods, a gas barrier layer against water vapor, oxygen, or the like, and an inorganic layer such as a light-controlling layer may be formed on the surface of the polyimide film by sputtering, vapor deposition, gel-sol process, or the like, as necessary, before the conductive layer is formed.

In addition, a circuit may be suitably formed on the conductive layer by photolithography process, various printing processes, ink-jet process, or the like.

The substrate of the present invention thus obtained has a circuit of a conductive layer on a surface of a polyimide film formed of the polyimide of the second embodiment of the present invention or the polyimide of the third embodiment of the present invention, optionally with a gas barrier layer or an inorganic layer therebetween, as necessary. The substrate is flexible, and has high transparency, and excellent mechanical properties, bending resistance and heat resistance, and also has a low coefficient of linear thermal expansion and excellent solvent resistance, and therefore a fine circuit may be easily formed thereon. Accordingly, the substrate may be suitably used as a substrate for a display, a touch panel, or a solar battery.

More specifically, a flexible thin-film transistor is produced by further forming a transistor (inorganic transistor, or organic transistor) on the substrate by vapor deposition, various printing processes, ink-jet process, or the like, and is suitably used as a liquid crystal device for display device, an EL device, or a photoelectric device.

### EXAMPLES

The present invention will be further described below with reference to Examples and Comparative Examples. However, the present invention is not limited to the Examples as described below.

In each of the Examples as described below, the evaluations were conducted by the following methods.

### <Evaluation of Polyimide Film>

[Light Transmittance at 400 nm]

The light transmittance at 400 nm of the polyimide film was measured using a UV-visible spectrophotometer V-650DS (made by JASCO Corporation).

[YI]

The YI of the polyimide film was measured in accordance with ASTEM E313 standard using a UV-visible spectrophotometer V-650DS (made by JASCO Corporation). The light source was D65 and the viewing angle was 2°.

[Haze]

The haze of the polyimide film was measured in accordance with JIS K7136 standard using a turbidity meter NDH2000 (made by Nippon Denshoku Industries Co., Ltd.).

[Tensile Modulus of Elasticity, Elongation at Break, Load at Break]

The polyimide film was cut to the dumbbell shape of IEC-540(S) standard, which was used as a test piece (width: 4 mm), and the initial tensile modulus of elasticity, the elongation at break, and the load at break were measured at a distance between chucks of 30 mm and a tensile speed of 2 mm/min using a TENSILON made by Orientec Co., Ltd.

[Coefficient of Linear Thermal Expansion (CTE)]

The polyimide film was cut to a rectangle having a width of 4 mm, which was used as a test piece, and the test piece was heated to 500° C. at a distance between chucks of 15 mm, a load of 2 g and a temperature-increasing rate of 20° C./min using a TMA/SS6100 (made by SII Nanotechnology Inc.). The coefficient of linear thermal expansion from 100° C. to 250° C. was determined from the obtained TMA curve.

[5% Weight Loss Temperature]

The polyimide film was used as a test piece, and the test piece was heated from 25° C. to 600° C. at a temperature-increasing rate of 10° C./min in a flow of nitrogen using a thermogravimetric analyzer (Q5000IR) made by TA Instruments Inc. The 5% weight loss temperature was determined from the obtained weight curve.

[Solvent Resistance Test]

The polyimide film was used as a test piece, and the test piece was immersed in N-methyl-2-pyrrolidone for 1 hour. The one in which a change such as dissolution and white-turbidity of the polyimide film was not observed was evaluated as ∘, and the one in which a change was observed was evaluated as x.

The abbreviations, purities, etc. of the raw materials used in each of the Examples as described below are as follows.

[Diamine Component]

m-TD: 2,2′-dimethyl-4,4′-diaminobiphenyl [purity: 99.85% (GC analysis)]
TFMB: 2,2′-bis(trifluoromethyl)benzidine [purity: 99.83% (GC analysis)]
PPD: p-phenylenediamine [purity: 99.9% (GC analysis)]
4,4′-ODA: 4,4′-oxydianiline [purity: 99.9% (GC analysis)]
BAPB: 4,4′-bis(4-aminophenoxy)biphenyl [purity: 99.93% (HPLC analysis)]
TPE-Q: 1,4-bis(4-aminophenoxy)benzene
TPE-R: 1,3-bis(4-aminophenoxy)benzene

[Tetracarboxylic Acid Component]

CBDA: 1,2,3,4-cyclobutane tetracarboxylic dianhydride [purity: 99.9% (GC analysis)]
CpODA: norbornane-2-spiro-α-cyclopentanone-α′-spiro-2″-norbornane-5,5″,6,6″-tetracarboxylic dianhydride
PMDA: pyromellitic dianhydride
ODPA: 4,4′-oxydiphthalic dianhydride

[Imidazole Compound]

1,2-dimethylimidazole
1-methylimidazole
imidazole

[Trialkylamine Compound]

triethylamine

[Compound Other than Imidazole and Trialkylamine]

pyridine
isoquinoline

[Solvent]

### DMAc: N,N-dimethylacetamide

The structural formulas of the tetracarboxylic acid components used in Examples and Comparative Examples, the diamine components used in Examples and Comparative Examples, the imidazole compounds used in Examples and Comparative Examples, the trialkylamine compound used in Examples and Comparative Examples, and the compounds other than imidazole and trialkylamine used in Examples and Comparative Examples are shown in Table 1-1, Table 1-2, Table 1-3, Table 1-4, and Table 1-5, respectively.

TABLE 1-1
Tetracarboxylic dianhydride

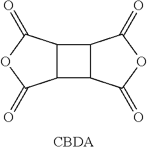 [SMILES: O=C1OC(=O)C2C1C1C(=O)OC(=O)C21]

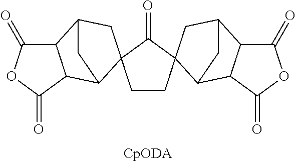 [SMILES: O=C1OC(=O)C2C1C1CC2C2(CCC3(CC4CC3C3C(=O)OC(=O)C43)C2=O)C1]

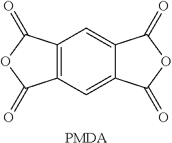

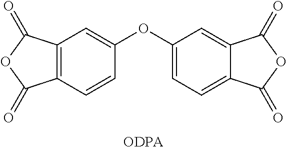 [SMILES: O=C1OC(=O)c2cc(Oc3ccc4c(c3)C(=O)OC4=O)ccc21]

TABLE 1-2
Diamine

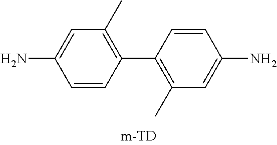 [SMILES: Cc1cc(N)ccc1-c1ccc(N)cc1C]

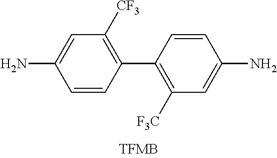 [SMILES: Nc1ccc(-c2ccc(N)cc2C(F)(F)F)c(C(F)(F)F)c1]

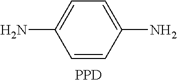

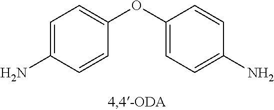 [SMILES: Nc1ccc(Oc2ccc(N)cc2)cc1]

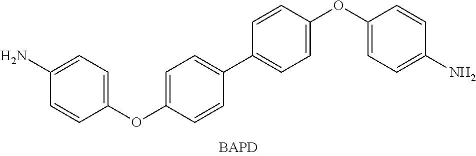 [SMILES: Nc1ccc(Oc2ccc(-c3ccc(Oc4ccc(N)cc4)cc3)cc2)cc1]

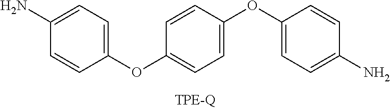 [SMILES: Nc1ccc(Oc2ccc(Oc3ccc(N)cc3)cc2)cc1]

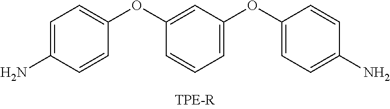 [SMILES: Nc1ccc(Oc2cccc(Oc3ccc(N)cc3)c2)cc1]

TABLE 1-3
Imidazole compound

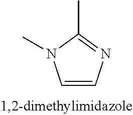

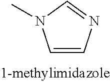

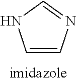

TABLE 1-4
Trialkylamine compound

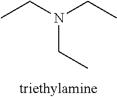

TABLE 1-5
Compound other than Imidazole and Trialkylamine

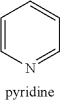

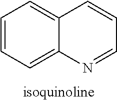

### Example A1

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish A).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish A) was added to the varnish A, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution, which was filtered through a PTFE membrane filter, was applied on a glass substrate, and then the polyimide precursor was thermally imidized by heating the polyimide precursor solution on the glass substrate from room temperature to 260° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 61 μm.

The results of the measurements of the properties of the polyimide film are shown in Table 2-1.

### Reference Example A1

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example A1, to provide a polyimide film having a thickness of 57 μm.

The results of the measurements of the properties of the polyimide film are shown in Table 2-1.

### Example A2

1.96 g (9 mmol) of m-TD and 0.32 g (1 mmol) of TFMB were placed in a reaction vessel, which was purged with nitrogen gas, and 22.01 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish B).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish B) was added to the varnish B, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 62 μm.

The results of the measurements of the properties of the polyimide film are shown in Table 2-1.

### Reference Example A2

1.96 g (9 mmol) of m-TD and 0.32 g (1 mmol) of TFMB were placed in a reaction vessel, which was purged with nitrogen gas, and 22.01 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example A1, to provide a polyimide film having a thickness of 70 μm.

The results of the measurements of the properties of the polyimide film are shown in Table 2-1.

### Example A3

1.49 g (7 mmol) of m-TD and 0.96 g (3 mmol) of TFMB were placed in a reaction vessel, which was purged with nitrogen gas, and 23.14 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish C).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish C) was added to the varnish C, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 79 μm.

The results of the measurements of the properties of the polyimide film are shown in Table 2-1.

### Reference Example A3

1.49 g (7 mmol) of m-TD and 0.96 g (3 mmol) of TFMB were placed in a reaction vessel, which was purged with nitrogen gas, and 23.14 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example A1, to provide a polyimide film having a thickness of 83 μm.

The results of the measurements of the properties of the polyimide film are shown in Table 2-1.

### Comparative Example A1

1.06 g (5 mmol) of m-TD and 1.60 g (5 mmol) of TFMB were placed in a reaction vessel, which was purged with nitrogen gas, and 24.27 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 260° C. in a nitrogen atmosphere (oxygen concentration: 200 ppm or less), but cracks appeared in the polyimide layer and a polyimide film could not be obtained.

### Comparative Example A2

3.20 g (10 mmol) of TFMB was placed in a reaction vessel, which was purged with nitrogen gas, and 247.11 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 260° C. in a nitrogen atmosphere (oxygen concentration: 200 ppm or less), but cracks appeared in the polyimide layer and a polyimide film could not be obtained.

### Comparative Example A3

3.20 g (10 mmol) of TFMB was placed in a reaction vessel, which was purged with nitrogen gas, and 247.11 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish D).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish D) was added to the varnish D, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 70 μm.

### Example A4

1.96 g (9 mmol) of m-TD and 0.11 g (1 mmol) of PPD were placed in a reaction vessel, which was purged with nitrogen gas, and 20.89 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish E).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish E) was added to the varnish E, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 63 μm.

The results of the measurements of the properties of the polyimide film are shown in Table 2-2.

### Reference Example A4

1.96 g (9 mmol) of m-TD and 0.11 g (1 mmol) of PPD were placed in a reaction vessel, which was purged with nitrogen gas, and 20.89 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example A1, to provide a polyimide film having a thickness of 64 μm.

The results of the measurements of the properties of the polyimide film are shown in Table 2-2.

### Example A5

1.49 g (7 mmol) of m-TD and 0.32 g (3 mmol) of PPD were placed in a reaction vessel, which was purged with nitrogen gas, and 19.80 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish F).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish F) was added to the varnish F, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 66 μm.

The results of the measurements of the properties of the polyimide film are shown in Table 2-2.

### Reference Example A5

1.49 g (7 mmol) of m-TD and 0.32 g (3 mmol) of PPD were placed in a reaction vessel, which was purged with nitrogen gas, and 19.80 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example A1, to provide a polyimide film having a thickness of 67 μm.

The results of the measurements of the properties of the polyimide film are shown in Table 2-2.

### Example A6

1.96 g (9 mmol) of m-TD and 0.20 g (1 mmol) of 4,4′-ODA were placed in a reaction vessel, which was purged with nitrogen gas, and 21.38 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish G).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish G) was added to the varnish G, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 50 μm.

The results of the measurements of the properties of the polyimide film are shown in Table 2-2.

### Example A7

1.96 g (9 mmol) of m-TD and 0.20 g (1 mmol) of 4,4′-ODA were placed in a reaction vessel, which was purged with nitrogen gas, and 21.38 g of DMAc was added thereto such that the total mass of the charged monomers (total mass of the diamine component and the carboxylic acid component) was 16 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example A1, to provide a polyimide film having a thickness of 53 μm.

The results of the measurements of the properties of the polyimide film are shown in Table 2-2.

### Example A8

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish H).

0.16 g of 1-methylimidazole and 0.16 g of DMAc were placed in a reaction vessel, and a homogeneous solution was obtained therefrom. All of the solution (2 mmol relative to the molecular weight of the repeating unit of the polyimide precursor in the varnish H) was added to the varnish H, and then the mixture was stirred at room temperature for 30 minutes, to provide a homogeneous and viscous polyimide precursor solution. The amount of 1-methylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 53 μm.

The results of the measurements of the properties of the polyimide film are shown in Table 2-2.

### Example A9

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish I).

0.14 g of imidazole and 0.14 g of DMAc were placed in a reaction vessel, and a homogeneous solution was obtained therefrom. All of the solution (2 mmol relative to the molecular weight of the repeating unit of the polyimide precursor in the varnish I) was added to the varnish I, and then the mixture was stirred at room temperature for 30 minutes, to provide a homogeneous and viscous polyimide precursor solution. The amount of imidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 51 μm.

The results of the measurements of the properties of the polyimide film are shown in Table 2-2.

### Example A10

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish J).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish J) was added to the varnish J, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 60 μm.

The results of the measurements of the properties of the polyimide film are shown in Table 2-3.

### Example A11

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish K).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish K) was added to the varnish K, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 62 μm.

The results of the measurements of the properties of the polyimide film are shown in Table 2-3.

### Example A12

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish L).

0.96 g of 1,2-dimethylimidazole and 0.96 g of DMAc were placed in a reaction vessel, and a homogeneous solution was obtained therefrom. All of the solution (10 mmol relative to the molecular weight of the repeating unit of the polyimide precursor in the varnish L) was added to the varnish L, and then the mixture was stirred at room temperature for 30 minutes, to provide a homogeneous and viscous polyimide precursor solution. The amount of 1,2-dimethylimidazole, which was calculated from the charge weights, was 1.0 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 62 μm.

The results of the measurements of the properties of the polyimide film are shown in Table 2-3.

### Example A13

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish M).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish M) was added to the varnish M, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 14 μm.

The results of the measurements of the properties of the polyimide film are shown in Table 2-3.

### Example A14

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish N).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish N) was added to the varnish N, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 37 μm.

The results of the measurements of the properties of the polyimide film are shown in Table 2-3.

### Example A15

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish O).

0.20 g of triethylamine and 0.20 g of DMAc were placed in a reaction vessel, and a homogeneous solution was obtained therefrom. All of the solution (2 mmol relative to the molecular weight of the repeating unit of the polyimide precursor in the varnish O) was added to the varnish 0, and then the mixture was stirred at room temperature for 30 minutes, to provide a homogeneous and viscous polyimide precursor solution. The amount of triethylamine, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 65 μm.

The results of the measurements of the properties of the polyimide film are shown in Table 2-3.

### Comparative Example A4

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish P).

0.16 g of pyridine and 0.16 g of DMAc were placed in a reaction vessel, and a homogeneous solution was obtained therefrom. All of the solution (2 mmol relative to the molecular weight of the repeating unit of the polyimide precursor in the varnish P) was added to the varnish P, and then the mixture was stirred at room temperature for 30 minutes, to provide a homogeneous and viscous polyimide precursor solution. The amount of pyridine, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 64 μm.

The results of the measurements of the properties of the polyimide film are shown in Table 2-3.

### Comparative Example A5

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish Q).

0.26 g of isoquinoline and 0.26 g of DMAc were placed in a reaction vessel, and a homogeneous solution was obtained therefrom. All of the solution (2 mmol relative to the molecular weight of the repeating unit of the polyimide precursor in the varnish Q) was added to the varnish Q, and then the mixture was stirred at room temperature for 30 minutes, to provide a homogeneous and viscous polyimide precursor solution. The amount of isoquinoline, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example A1, to provide a polyimide film having a thickness of 65 μm.

The results of the measurements of the properties of the polyimide film are shown in Table 2-3.

### Example B1

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 300° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 50 μm.

The results of the measurements of the properties of the polyimide film are shown in Table 2-4.

### Example B2

2.12 g (10 mmol) of m-TD was placed in a reaction vessel, which was purged with nitrogen gas, and 24.41 g of DMAc was added thereto such that the total mass of the charged monomers (total mass of the diamine component and the carboxylic acid component) was 16 mass %, and then the mixture was stirred at room temperature for 1 hour. 1.37 g (7 mmol) of CBDA and 1.15 g (3 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 55 μm.

The results of the measurements of the properties of the polyimide film are shown in Table 2-4.

### Example B3

2.12 g (10 mmol) of m-TD was placed in a reaction vessel, which was purged with nitrogen gas, and 26.38 g of DMAc was added thereto such that the total mass of the charged monomers (total mass of the diamine component and the carboxylic acid component) was 16 mass %, and then the mixture was stirred at room temperature for 1 hour. 0.98 g (5 mmol) of CBDA and 1.92 g (5 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 54 μm.

The results of the measurements of the properties of the polyimide film are shown in Table 2-4.

### Example B4

2.12 g (10 mmol) of m-TD was placed in a reaction vessel, which was purged with nitrogen gas, and 28.36 g of DMAc was added thereto such that the total mass of the charged monomers (total mass of the diamine component and the carboxylic acid component) was 16 mass %, and then the mixture was stirred at room temperature for 1 hour. 0.59 g (3 mmol) of CBDA and 2.69 g (7 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 55 μm.

The results of the measurements of the properties of the polyimide film are shown in Table 2-4.

### Comparative Example B1

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 50 μm.

The results of the measurements of the properties of the polyimide film are shown in Table 2-4.

### Example B5

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish R).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish R) was added to the varnish R, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 50 μm.

The results of the measurements of the properties of the polyimide film are shown in Table 2-4.

### Example B6

2.12 g (10 mmol) of m-TD was placed in a reaction vessel, which was purged with nitrogen gas, and 24.41 g of DMAc was added thereto such that the total mass of the charged monomers (total mass of the diamine component and the carboxylic acid component) was 16 mass %, and then the mixture was stirred at room temperature for 1 hour. 1.37 g (7 mmol) of CBDA and 1.15 g (3 mmol) of CpODA were gradually added to the resulting solution. The mixture was stirred at room temperature for 12 hours, to provide a homogeneous and viscous polyimide precursor solution (varnish S).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish S) was added to the varnish S, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 60 μm.

The results of the measurements of the properties of the polyimide film are shown in Table 2-4.

### Example B7

2.12 g (10 mmol) of m-TD was placed in a reaction vessel, which was purged with nitrogen gas, and 26.38 g of DMAc was added thereto such that the total mass of the charged monomers (total mass of the diamine component and the carboxylic acid component) was 16 mass %, and then the mixture was stirred at room temperature for 1 hour. 0.98 g (5 mmol) of CBDA and 1.92 g (5 mmol) of CpODA were gradually added to the resulting solution. The mixture was stirred at room temperature for 12 hours, to provide a homogeneous and viscous polyimide precursor solution (varnish T).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish T) was added to the varnish T, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 61 μm.

The results of the measurements of the properties of the polyimide film are shown in Table 2-4.

### Example B8

2.12 g (10 mmol) of m-TD was placed in a reaction vessel, which was purged with nitrogen gas, and 28.36 g of DMAc was added thereto such that the total mass of the charged monomers (total mass of the diamine component and the carboxylic acid component) was 16 mass %, and then the mixture was stirred at room temperature for 1 hour. 0.59 g (3 mmol) of CBDA and 2.69 g (7 mmol) of CpODA were gradually added to the resulting solution. The mixture was stirred at room temperature for 12 hours, to provide a homogeneous and viscous polyimide precursor solution (varnish U).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish U) was added to the varnish U, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 55 μm.

The results of the measurements of the properties of the polyimide film are shown in Table 2-4.

### Example B9

2.12 g (10 mmol) of m-TD was placed in a reaction vessel, which was purged with nitrogen gas, and 30.34 g of DMAc was added thereto such that the total mass of the charged monomers (total mass of the diamine component and the carboxylic acid component) was 16 mass %, and then the mixture was stirred at room temperature for 1 hour. 0.20 g (1 mmol) of CBDA and 3.46 g (9 mmol) of CpODA were gradually added to the resulting solution. The mixture was stirred at room temperature for 12 hours, to provide a homogeneous and viscous polyimide precursor solution (varnish V).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish V) was added to the varnish V, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 61 μm.

The results of the measurements of the properties of the polyimide film are shown in Table 2-4.

### Example B10

2.12 g (10 mmol) of m-TD was placed in a reaction vessel, which was purged with nitrogen gas, and 25.09 g of DMAc was added thereto such that the total mass of the charged monomers (total mass of the diamine component and the carboxylic acid component) was 14 mass %, and then the mixture was stirred at room temperature for 1 hour. 1.96 g (10 mmol) of CBDA was gradually added to the resulting solution. The mixture was stirred at room temperature for 12 hours, to provide a homogeneous and viscous polyimide precursor solution (varnish W).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish W) was added to the varnish W, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 57 μm.

The results of the measurements of the properties of the polyimide film are shown in Table 2-4.

### Example B11

1.49 g (7 mmol) of m-TD and 0.96 g (3 mmol) of TFMB were placed in a reaction vessel, which was purged with nitrogen gas, and 24.13 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 57 μm.

The results of the measurements of the properties of the polyimide film are shown in Table 2-5.

### Example B12

1.49 g (7 mmol) of m-TD and 0.32 g (3 mmol) of PPD were placed in a reaction vessel, which was purged with nitrogen gas, and 20.79 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 62 μm.

The results of the measurements of the properties of the polyimide film are shown in Table 2-5.

### Example B13

1.96 g (9 mmol) of m-TD and 0.20 g (1 mmol) of 4,4′-ODA were placed in a reaction vessel, which was purged with nitrogen gas, and 22.37 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution.

The polyimide precursor solution was imidized on a glass substrate, and then the obtained polyimide film was peeled from the glass substrate and dried in the same way as in Example B1, to provide a polyimide film having a thickness of 50 μm.

The results of the measurements of the properties of the polyimide film are shown in Table 2-5.

### Example B14

1.49 g (7 mmol) of m-TD and 0.96 g (3 mmol) of TFMB were placed in a reaction vessel, which was purged with nitrogen gas, and 24.13 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish X).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish X) was added to the varnish X, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 68 μm.

The results of the measurements of the properties of the polyimide film are shown in Table 2-5.

### Example B15

1.49 g (7 mmol) of m-TD and 0.32 g (3 mmol) of PPD were placed in a reaction vessel, which was purged with nitrogen gas, and 20.79 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish Y).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish Y) was added to the varnish Y, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 72 μm.

The results of the measurements of the properties of the polyimide film are shown in Table 2-5.

### Example B16

1.96 g (9 mmol) of m-TD and 0.20 g (1 mmol) of 4,4′-ODA were placed in a reaction vessel, which was purged with nitrogen gas, and 22.37 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish Z).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish Z) was added to the varnish Z, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 66 μm.

The results of the measurements of the properties of the polyimide film are shown in Table 2-5.

### Example B17

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish a).

0.16 g of 1-methylimidazole and 0.16 g of DMAc were placed in a reaction vessel, and a homogeneous solution was obtained therefrom. All of the solution (2 mmol relative to the molecular weight of the repeating unit of the polyimide precursor in the varnish a) was added to the varnish a, and then the mixture was stirred at room temperature for 30 minutes, to provide a homogeneous and viscous polyimide precursor solution. The amount of 1-methylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 56 μm.

The results of the measurements of the properties of the polyimide film are shown in Table 2-5.

### Example B18

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish b).

0.14 g of imidazole and 0.14 g of DMAc were placed in a reaction vessel, and a homogeneous solution was obtained therefrom. All of the solution (2 mmol relative to the molecular weight of the repeating unit of the polyimide precursor in the varnish b) was added to the varnish b, and then the mixture was stirred at room temperature for 30 minutes, to provide a homogeneous and viscous polyimide precursor solution. The amount of imidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 57 μm.

The results of the measurements of the properties of the polyimide film are shown in Table 2-5.

### Example B19

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish c).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish c) was added to the varnish c, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 57 μm.

The results of the measurements of the properties of the polyimide film are shown in Table 2-5.

### Example B20

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish d).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish d) was added to the varnish d, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 54 μm.

The results of the measurements of the properties of the polyimide film are shown in Table 2-5.

### Reference Example B1

2.12 g (10 mmol) of m-TD was placed in a reaction vessel, which was purged with nitrogen gas, and 31.33 g of DMAc was added thereto such that the total mass of the charged monomers (total mass of the diamine component and the carboxylic acid component) was 16 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution (varnish e).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish e) was added to the varnish e, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 58 μm.

The results of the measurements of the properties of the polyimide film are shown in Table 2-6.

### Reference Example B2

2.12 g (10 mmol) of m-TD was placed in a reaction vessel, which was purged with nitrogen gas, and 31.33 g of DMAc was added thereto such that the total mass of the charged monomers (total mass of the diamine component and the carboxylic acid component) was 16 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), but cracks appeared in the polyimide layer and a polyimide film having a size enough to evaluate the properties could not be obtained. The thickness of the obtained polyimide film was 50 μm.

### Reference Example B3

2.12 g (10 mmol) of m-TD was placed in a reaction vessel, which was purged with nitrogen gas, and 31.33 g of DMAc was added thereto such that the total mass of the charged monomers (total mass of the diamine component and the carboxylic acid component) was 16 mass %, and then the mixture was stirred at room temperature for 1 hour. 3.84 g (10 mmol) of CpODA was gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 420° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 10 μm.

The results of the measurements of the properties of the polyimide film are shown in Table 2-6.

### Example B21

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish f).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish f) was added to the varnish f, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 12 μm.

The results of the measurements of the properties of the polyimide film are shown in Table 2-6.

### Example B22

2.12 g (10 mmol) of m-TD was placed in a reaction vessel, which was purged with nitrogen gas, and 22.43 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish g).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish g) was added to the varnish g, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 38 μm.

The results of the measurements of the properties of the polyimide film are shown in Table 2-6.

### Comparative Example B2

2.12 g (10 mmol) of m-TD was placed in a reaction vessel, which was purged with nitrogen gas, and 28.57 g of DMAc was added thereto such that the total mass of the charged monomers (total mass of the diamine component and the carboxylic acid component) was 14 mass %, and then the mixture was stirred at room temperature for 1 hour. 0.20 g (1 mmol) of CBDA, 1.09 g (5 mmol) of PMDA and 1.24 g (4 mmol) of ODPA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 21 μm.

The results of the measurements of the properties of the polyimide film are shown in Table 2-6.

### Comparative Example B3

2.12 g (10 mmol) of m-TD was placed in a reaction vessel, which was purged with nitrogen gas, and 26.89 g of DMAc was added thereto such that the total mass of the charged monomers (total mass of the diamine component and the carboxylic acid component) was 14 mass %, and then the mixture was stirred at room temperature for 1 hour. 0.98 g (5 mmol) of CBDA, 0.65 g (3 mmol) of PMDA and 0.62 g (2 mmol) of ODPA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 19 μm.

The results of the measurements of the properties of the polyimide film are shown in Table 2-6.

### Comparative Example B4

3.14 g (9.8 mmol) of TFMB was placed in a reaction vessel, which was purged with nitrogen gas, and 29.50 g of DMAc was added thereto such that the total mass of the charged monomers (total mass of the diamine component and the carboxylic acid component) was 16 mass %, and then the mixture was stirred at room temperature for 1 hour. 0.20 g (1 mmol) of CBDA, 1.09 g (5 mmol) of PMDA and 1.24 g (4 mmol) of ODPA were gradually added to the resulting solution. The mixture was stirred at room temperature for 12 hours, to provide a homogeneous and viscous polyimide precursor solution.

The polyimide precursor solution, which was filtered through a PTFE membrane filter, was applied on a glass substrate, and then the polyimide precursor was thermally imidized by heating the polyimide precursor solution on the glass substrate from room temperature to 330° C. in a nitrogen atmosphere (oxygen concentration: 200 ppm or less), to provide a colorless and transparent polyimide film/glass laminate. Subsequently, the obtained polyimide film/glass laminate was immersed in water, and then the polyimide film was peeled from the glass and dried, to provide a polyimide film having a thickness of 20 μm.

The results of the measurements of the properties of the polyimide film are shown in Table 2-6.

### Example B23

1.45 g (6.85 mmol) of m-TD and 0.63 g (3.15 mmol) of 4,4′-ODA were placed in a reaction vessel, which was purged with nitrogen gas, and 22.23 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish h).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish h) was added to the varnish h, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B24

1.45 g (6.85 mmol) of m-TD and 0.63 g (3.15 mmol) of 4,4′-ODA were placed in a reaction vessel, which was purged with nitrogen gas, and 22.23 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish i).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish i) was added to the varnish i, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B25

1.45 g (6.85 mmol) of m-TD and 0.63 g (3.15 mmol) of 4,4′-ODA were placed in a reaction vessel, which was purged with nitrogen gas, and 22.23 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish j).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish j) was added to the varnish j, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 50 μm.

The results of the measurements of the properties of the polyimide film are shown in Table 2-7.

### Example B26

1.77 g (8.00 mmol) of m-TD and 0.74 g (2.00 mmol) of BAPB were placed in a reaction vessel, which was purged with nitrogen gas, and 24.07 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish k).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish k) was added to the varnish k, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B27

1.77 g (8.00 mmol) of m-TD and 0.74 g (2.00 mmol) of BAPB were placed in a reaction vessel, which was purged with nitrogen gas, and 24.07 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish 1).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish 1) was added to the varnish 1, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B28

1.77 g (8.00 mmol) of m-TD and 0.74 g (2.00 mmol) of BAPB were placed in a reaction vessel, which was purged with nitrogen gas, and 24.07 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish m).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish m) was added to the varnish m, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 52 μm.

The results of the measurements of the properties of the polyimide film are shown in Table 2-7.

### Example B29

1.61 g (7.60 mmol) of m-TD and 0.70 g (2.40 mmol) of TPE-Q were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish n).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish n) was added to the varnish n, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 44 μm.

The results of the measurements of the properties of the polyimide film are shown in Table 2-7.

### Example B30

1.61 g (7.60 mmol) of m-TD and 0.70 g (2.40 mmol) of TPE-Q were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish o).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish o) was added to the varnish o, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B31

1.61 g (7.60 mmol) of m-TD and 0.70 g (2.40 mmol) of TPE-Q were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish p).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish p) was added to the varnish p, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B32

1.61 g (7.60 mmol) of m-TD and 0.70 g (2.40 mmol) of TPE-R were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish n).

0.10 g of 1,2-dimethylimidazole and 0.10 g of DMAc were placed in a reaction vessel, and a homogeneous solution was obtained therefrom. All of the solution (1 mmol relative to the molecular weight of the repeating unit of the polyimide precursor in the varnish n) was added to the varnish n, and then the mixture was stirred at room temperature for 30 minutes, to provide a homogeneous and viscous polyimide precursor solution. The amount of 1,2-dimethylimidazole, which was calculated from the charge weights, was 0.1 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 44 μm.

The results of the measurements of the properties of the polyimide film are shown in Table 2-7.

### Example B33

1.61 g (7.60 mmol) of m-TD and 0.70 g (2.40 mmol) of TPE-R were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish o).

0.19 g of 1,2-dimethylimidazole and 0.19 g of DMAc were placed in a reaction vessel, and a homogeneous solution was obtained therefrom. All of the solution (2 mmol relative to the molecular weight of the repeating unit of the polyimide precursor in the varnish o) was added to the varnish o, and then the mixture was stirred at room temperature for 30 minutes, to provide a homogeneous and viscous polyimide precursor solution. The amount of 1,2-dimethylimidazole, which was calculated from the charge weights, was 0.2 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 42 μm.

The results of the measurements of the properties of the polyimide film are shown in Table 2-7.

### Example B34

1.61 g (7.60 mmol) of m-TD and 0.70 g (2.40 mmol) of TPE-R were placed in a reaction vessel, which was purged with nitrogen gas, and 23.44 g of DMAc was added thereto such that the total mass of the charged monomers (total mass of the diamine component and the carboxylic acid component) was 16 mass %, and then the mixture was stirred at room temperature for 1 hour. 1.76 g (9 mmol) of CBDA and 0.38 g (1 mmol) of CpODA were gradually added to the resulting solution. The mixture was stirred at room temperature for 12 hours, to provide a homogeneous and viscous polyimide precursor solution (varnish p).

0.38 g of 1,2-dimethylimidazole and 0.38 g of DMAc were placed in a reaction vessel, and a homogeneous solution was obtained therefrom. All of the solution (4 mmol relative to the molecular weight of the repeating unit of the polyimide precursor in the varnish p) was added to the varnish p, and then the mixture was stirred at room temperature for 30 minutes, to provide a homogeneous and viscous polyimide precursor solution. The amount of 1,2-dimethylimidazole, which was calculated from the charge weights, was 0.4 mol relative to 1 mol of the repeating unit of the polyimide precursor.

The polyimide precursor solution was imidized on a glass substrate, and then the obtained polyimide film was peeled from the glass substrate and dried in the same way as in Example B1, to provide a polyimide film having a thickness of 40 μm.

The results of the measurements of the properties of the polyimide film are shown in Table 2-7.

TABLE 2-1

| | | | | | | | | | Com- | Com- |
|---|---|---|---|---|---|---|---|---|---|---|
| | | | Reference | | Reference | | Reference | | parative | parative |
| | | Example | Example | Example | Example | Example | Example | Comparative | Example | Example |
| | | A1 | A1 | A2 | A2 | A3 | A3 | Example A1 | A2 | A3 |
| Dianhydride | CBDA | 10.0 | 10.0 | 10.0 | 10.0 | 10.0 | 10.0 | 10.0 | 10.0 | 10.0 |
| Diamine | m-TD | 10.0 | 10.0 | 9.0 | 9.0 | 7.0 | 7.0 | 5.0 | | |
| | TFMB | | | 1.0 | 1.0 | 3.0 | 3.0 | 5.0 | 10.0 | 10.0 |
| | PPD | | | | | | | | | |
| | 4,4′-ODA | | | | | | | | | |
| Additive | 1,2-dimethylimidazole | 0.2 | | 0.2 | | 0.2 | | | | 0.2 |
| compound | 1-methylimidazole | | | | | | | | | |
| (equivalent/) | imidazole | | | | | | | | | |
| repeating unit | triethylamine | | | | | | | | | |
| | pyridine | | | | | | | | | |
| | isoquinoline | | | | | | | | | |

| | | | | | | | | | |
|---|---|---|---|---|---|---|---|---|---|
| Thickness/μm | 61 | 57 | 62 | 70 | 79 | 83 | 52 | 57 | 70 |
| Tensile modulus of elasticity/GPa | 6.1 | 6.0 | 7.2 | 4.7 | 5.8 | 5.4 | — | — | 4.9 |
| Elongation at break/% GL | 5 | 1 | 6 | 1 | 7 | 1 | — | — | 7 |
| Load at break/N | 42.9 | 5.9 | 53.6 | 6.2 | 55.6 | 8.0 | — | — | 42.3 |
| CTE@100-250° C./ppm · K⁻¹ | 8 | 16 | 8 | 22 | 10 | 21 | — | — | 27 |
| Transmittance at 400 nm/% | 84 | 84 | 85 | 84 | 81 | 80 | — | — | 81 |
| YI | 2.3 | 2.4 | 2.3 | 2.3 | 3.9 | 4.1 | — | — | 4.0 |
| Haze/% | 0.9 | 0.4 | 0.6 | 1.0 | 0.7 | 0.4 | — | — | 1.4 |
| 5% weight loss temperature/° C. | 436 | 436 | 435 | 438 | 432 | 402 | — | — | 421 |
| Solvent resistance | ◯ | ◯ | ◯ | ◯ | ◯ | ◯ | — | — | ◯ |

TABLE 2-2

| | | | Reference | | Reference | | | | |
|---|---|---|---|---|---|---|---|---|---|
| | | Example | Example | Example | Example | Example | Example | Example | Example |
| | | A4 | A4 | A5 | A5 | A6 | A7 | A8 | A9 |
| Dianhydride | CBDA | 10.0 | 10.0 | 10.0 | 10.0 | 10.0 | 10.0 | 10.0 | 10.0 |
| Diamine | m-TD | 9.0 | 9.0 | 7.0 | 7.0 | 9.0 | 9.0 | 10.0 | 10.0 |
| | TFMB | | | | | | | | |
| | PPD | 1.0 | 1.0 | 3.0 | 3.0 | | | | |
| | 4,4′-ODA | | | | | 1.0 | 1.0 | | |
| Additive | 1,2-dimethylimidazole | 0.2 | | 0.2 | | 0.2 | | | |
| compound | 1-methylimidazole | | | | | | | 0.2 | |
| (equivalent/ | imidazole | | | | | | | | 0.2 |
| repeating unit) | triethylamine | | | | | | | | |
| | pyridine | | | | | | | | |
| | isoquinoline | | | | | | | | |

| | | | | | | | | |
|---|---|---|---|---|---|---|---|---|
| Thickness/μm | 63 | 64 | 66 | 67 | 50 | 53 | 53 | 51 |
| Tensile modulus of elasticity/GPa | 6.1 | 6.7 | 6.1 | 5.0 | 6.6 | 6.5 | 7.0 | 7.5 |
| Elongation at break/% GL | 6 | 1 | 6 | 1 | 9 | 2 | 5 | 5 |
| Load at break/N | 47.4 | 7.7 | 47.3 | 10.2 | 46.1 | 18.2 | 56.3 | 46.6 |
| CTE@100-250° C./ppm · K⁻¹ | 16 | 19 | 20 | 15 | 19 | 25 | 11 | 17 |
| Transmittance at 400 nm/% | 82 | 79 | 83 | 82 | 85 | 84 | 85 | 85 |
| YI | 3.1 | 4.7 | 2.9 | 3.2 | 1.6 | 2.2 | 1.7 | 2.0 |
| Haze/% | 0.3 | 0.8 | 0.4 | 0.5 | 0.1 | 0.2 | 0.3 | 0.2 |
| 5% weight loss temperature/° C. | 438 | 447 | 436 | 433 | 435 | 430 | 415 | 425 |
| Solvent resistance | ◯ | ◯ | ◯ | ◯ | ◯ | ◯ | ◯ | ◯ |

TABLE 2-3

| | | Example | Example | Example | Example | Example | | Comparative | Comparative |
|---|---|---|---|---|---|---|---|---|---|
| | | A10 | A11 | A12 | A13 | A14 | Example A15 | Example A4 | Example A5 |
| Dianhydride | CBDA | 10.0 | 10.0 | 10.0 | 10.0 | 10.0 | 10.0 | 10.0 | 10.0 |
| Diamine | m-TD | 10.0 | 10.0 | 10.0 | 10.0 | 10.0 | 10.0 | 10.0 | 10.0 |
| | TFMB | | | | | | | | |
| | PPD | | | | | | | | |
| | 4,4′-ODA | | | | | | | | |
| Additive compound | 1,2-dimethylimidazole | 0.1 | 0.4 | 1 | 0.2 | 0.2 | | | |
| (equivalent/ | 1-methylimidazole | | | | | | | | |
| repeating unit) | imidazole | | | | | | | | |
| | triethylamine | | | | | | 0.2 | | |
| | pyridine | | | | | | | 0.2 | |
| | isoquinoline | | | | | | | | 0.2 |

| | | | | | | | | |
|---|---|---|---|---|---|---|---|---|
| Thickness/μm | 60 | 62 | 62 | 14 | 37 | 65 | 64 | 65 |
| Tensile modulus of elasticity/GPa | 7.4 | 7.4 | 7.8 | 8.5 | 8.0 | 7.0 | 6.8 | 7.6 |
| Elongation at break/% GL | 6 | 7 | 10 | 5 | 6 | 5 | 1 | 4 |
| Load at break/N | 55.7 | 56.8 | 58.8 | 16.2 | 35.1 | 49.7 | 17.6 | 51.8 |
| CTE@100-250° C./ppm · K⁻¹ | 20 | 8 | 7 | 11 | 14 | 20 | 23 | 18 |
| Transmittance at 400 nm/% | 85 | 84 | 83 | 85 | 85 | 83 | 75 | 77 |
| YI | 1.8 | 2.0 | 2.4 | 1.5 | 1.6 | 2.9 | 6.3 | 5.3 |
| Haze/% | 0.4 | 0.3 | 0.4 | 0.1 | 0.4 | 0.5 | 1.6 | 0.9 |
| 5% weight loss temperature/° C. | 442 | 441 | 435 | 447 | 443 | 380 | 435 | 411 |
| Solvent resistance | ◯ | ◯ | ◯ | ◯ | ◯ | ◯ | ◯ | ◯ |

TABLE 2-4

| | | Ex- | Ex- | Ex- | Ex- | | Ex- | Ex- | Ex- | Ex- | | |
|---|---|---|---|---|---|---|---|---|---|---|---|---|
| | | ample | ample | ample | ample | Comparative | ample | ample | ample | ample | Example | Example |
| | | B1 | B2 | B3 | B4 | Example B1 | B5 | B6 | B7 | B8 | B9 | B10 |
| Dianhydride | CBDA | 9.0 | 7.0 | 5.0 | 3.0 | 10.0 | 9.0 | 7.0 | 5.0 | 3.0 | 1.0 | 10.0 |
| | CpODA | 1.0 | 3.0 | 5.0 | 7.0 | 0 | 1.0 | 3.0 | 5.0 | 7.0 | 9.0 | 0 |
| | PMDA | | | | | | | | | | | |
| | ODPA | | | | | | | | | | | |
| Diamine | m-TD | 10.0 | 10.0 | 10.0 | 10.0 | 10.0 | 10.0 | 10.0 | 10.0 | 10.0 | 10.0 | 10.0 |
| | TFMB | | | | | | | | | | | |
| | PPD | | | | | | | | | | | |
| | 4,4′-ODA | | | | | | | | | | | |
| | BAPB | | | | | | | | | | | |
| | TPE-Q | | | | | | | | | | | |
| | TPE-R | | | | | | | | | | | |
| Additive | 1,2-dimethyl- | | | | | | 0.2 | 0.2 | 0.2 | 0.2 | 0.2 | 0.2 |
| compound | imidazole | | | | | | | | | | | |
| (equivalent/ | 1-methylimidazole | | | | | | | | | | | |
| repeating | imidazole | | | | | | | | | | | |
| unit) | | | | | | | | | | | | |

| | | | | | | | | | | | |
|---|---|---|---|---|---|---|---|---|---|---|---|
| Thickness/μm | 50 | 55 | 54 | 55 | 50 | 50 | 60 | 61 | 55 | 61 | 57 |
| Tensile modulus of elasticity/GPa | 6.0 | 6.3 | 5.7 | 5.8 | 7.1 | 7.3 | 6.0 | 5.3 | 5.2 | 5.3 | 6.5 |
| Elongation at break/% GL | 1 | 5 | 6 | 7 | 2 | 10 | 10 | 7 | 12 | 6 | 7 |
| Load at break/N | 12.4 | 41.1 | 37.2 | 35.4 | 24.5 | 40.7 | 47.5 | 42.2 | 42.9 | 37.6 | 48.8 |
| CTE@100-250° C./ppm · K⁻¹ | 25 | 26 | 29 | 29 | 15 | 13 | 13 | 20 | 23 | 15 | 8 |
| Transmittance at 400 nm/% | 85 | 86 | 84 | 83 | 81 | 84 | 84 | 86 | 86 | 87 | 82 |
| YI | 2.2 | 2.2 | 2.6 | 3.1 | 4.1 | 2.4 | 2.3 | 1.8 | 1.6 | 1.4 | 3.0 |
| Haze/% | 0.1 | 0.1 | 0.3 | 0.6 | 0.7 | 0.2 | 0.1 | 0.2 | 0.1 | 0.4 | 0.4 |
| 5% weight loss temperature/° C. | 457 | 466 | 467 | 475 | 448 | 463 | 466 | 466 | 473 | 482 | 449 |
| Solvent resistance | ◯ | ◯ | ◯ | ◯ | ◯ | ◯ | ◯ | ◯ | ◯ | ◯ | ◯ |

TABLE 2-5

| | | Example | Example | Example | Example | Example | Example | Example | Example | Example | Example |
|---|---|---|---|---|---|---|---|---|---|---|---|
| | | B11 | B12 | B13 | B14 | B15 | B16 | B17 | B18 | B19 | B20 |
| Dianhydride | CBDA | 9.0 | 9.0 | 9.0 | 9.0 | 9.0 | 9.0 | 9.0 | 9.0 | 9.0 | 9.0 |
| | CpODA | 1.0 | 1.0 | 1.0 | 1.0 | 1.0 | 1.0 | 1.0 | 1.0 | 1.0 | 1.0 |
| | PMDA | | | | | | | | | | |
| | ODPA | | | | | | | | | | |
| Diamine | m-TD | 7.0 | 7.0 | 9.0 | 7.0 | 7.0 | 9.0 | 10.0 | 10.0 | 10.0 | 10.0 |
| | TFMB | 3.0 | | | 3.0 | | | | | | |
| | PPD | | 3.0 | | | 3.0 | | | | | |
| | 4,4′-ODA | | | 1.0 | | | 1.0 | | | | |
| | BAPB | | | | | | | | | | |
| | TPE-Q | | | | | | | | | | |
| | TPE-R | | | | | | | | | | |
| Additive | 1,2-dimethyl- | | | | 0.2 | 0.2 | 0.2 | | | 0.1 | 0.4 |
| compound | imidazole | | | | | | | | | | |
| (equivalent/ | 1-methyl- | | | | | | | 0.2 | | | |
| repeating | imidazole | | | | | | | | | | |
| unit) | imidazole | | | | | | | | 0.2 | | |

| | | | | | | | | | | |
|---|---|---|---|---|---|---|---|---|---|---|
| Thickness/μm | 57 | 62 | 50 | 68 | 72 | 66 | 56 | 57 | 57 | 54 |
| Tensile modulus of elasticity/ | 6.3 | 5.9 | 6.3 | 6.0 | 6.5 | 6.3 | 6.9 | 6.6 | 7.1 | 7.4 |
| GPa | | | | | | | | | | |
| Elongation at break/% GL | 4 | 1 | 4 | 9 | 7 | 16 | 6 | 6 | 11 | 9 |
| Load at break/N | 47.8 | 10.2 | 29.7 | 61.0 | 66.1 | 68.1 | 51.1 | 50.3 | 54.9 | 49.7 |
| CTE@100-250° C./ppm · K⁻¹ | 9 | 7 | 26 | 14 | 12 | 18 | 13 | 16 | 19 | 12 |
| Transmittance at 400 nm/% | 80 | 81 | 83 | 83 | 82 | 82 | 84 | 83 | 83 | 82 |
| YI | 4.4 | 3.4 | 3.0 | 3.2 | 3.5 | 3.1 | 2.4 | 3.0 | 2.6 | 3.3 |
| Haze/% | 0.5 | 0.7 | 0.2 | 0.4 | 0.3 | 0.3 | 0.2 | 0.2 | 0.3 | 0.9 |
| 5% weight loss temperature/ | 456 | 450 | 458 | 466 | 462 | 466 | 466 | 467 | 470 | 463 |
| ° C. | | | | | | | | | | |
| Solvent resistance | ◯ | ◯ | ◯ | ◯ | ◯ | ◯ | ◯ | ◯ | ◯ | ◯ |

TABLE 2-6

| | | Reference | Reference | | | | | | |
|---|---|---|---|---|---|---|---|---|---|
| | | Example | Example | Reference | Example | Example | Comparative | Comparative | Comparative |
| | | B1 | B2 | Example B3 | B21 | B22 | Example B2 | Example B3 | Example B4 |
| Dianhydride | CBDA | | | | 9.0 | 9.0 | 1.0 | 5.0 | 1.0 |
| | CpODA | 10.0 | 10.0 | 10.0 | 1.0 | 1.0 | | | |
| | PMDA | | | | | | 5.0 | 3.0 | 5.0 |
| | ODPA | | | | | | 4.0 | 2.0 | 4.0 |
| Diamine | m-TD | 10.0 | 10.0 | 10.0 | 10.0 | 10.0 | 10.0 | 10.0 | |
| | TFMB | | | | | | | | 9.8 |
| | PPD | | | | | | | | |
| | 4,4′-ODA | | | | | | | | |
| | BAPB | | | | | | | | |
| | TPE-Q | | | | | | | | |
| | TPE-R | | | | | | | | |
| Additive compound | 1,2-dimethylimidazole | 0.2 | | | 0.2 | 0.2 | | | |
| (equivalent/ | 1-methylimidazole | | | | | | | | |
| repeating unit) | imidazole | | | | | | | | |

| | | | | | | | | |
|---|---|---|---|---|---|---|---|---|
| Thickness/μm | 58 | 50 | 10 | 12 | 38 | 21 | 19 | 20 |
| Tensile modulus of elasticity/GPa | 5.2 | — | 4.4 | 7.3 | 7.4 | 5.5 | 6.5 | 4.3 |
| Elongation at break/% GL | 10 | — | 30 | 5 | 6 | 28 | 11 | 27 |
| Load at break/N | 41.3 | — | 7.0 | 17.1 | 34.7 | 24.1 | 17.6 | 16.3 |
| CTE@100-250° C./ppm · K⁻¹ | 7 | — | 48 | 14 | 22 | 16 | 21 | 12 |
| Transmittance at 400 nm/% | 83 | — | 89 | 86 | 85 | 1 | 5 | 28 |
| YI | 2.7 | — | 1.1 | 1.4 | 1.7 | 51.3 | 40.2 | 12.6 |
| Haze/% | 4.2 | — | 0.2 | 0.2 | 0.2 | 0.2 | 0.1 | 0.3 |
| 5% weight loss temperature/° C. | 377 | — | 474 | 452 | 443 | 489 | 462 | 556 |
| Solvent resistance | ◯ | — | ◯ | ◯ | ◯ | ◯ | ◯ | ◯ |

TABLE 2-7

| | | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|
| | | ample | ample | ample | ample | ample | ample | ample | ample | ample | ample | ample | ample |
| | | B23 | B24 | B25 | B26 | B27 | B28 | B29 | B30 | B31 | B32 | B33 | B34 |
| Dianhydride | CBDA | 9.0 | 9.0 | 9.0 | 9.0 | 9.0 | 9.0 | 9.0 | 9.0 | 9.0 | 9.0 | 9.0 | 9.0 |
| | CpODA | 1.0 | 1.0 | 1.0 | 1.0 | 1.0 | 1.0 | 1.0 | 1.0 | 1.0 | 1.0 | 1.0 | 1.0 |
| | PMDA | | | | | | | | | | | | |
| | ODPA | | | | | | | | | | | | |
| Diamine | m-TD | 6.85 | 6.85 | 6.85 | 8.0 | 8.0 | 8.0 | 7.6 | 7.6 | 7.6 | 7.6 | 7.6 | 7.6 |
| | TFMB | | | | | | | | | | | | |
| | PPD | | | | | | | | | | | | |
| | 4,4′-ODA | 3.15 | 3.15 | 3.15 | | | | | | | | | |
| | BAPB | | | | 2.0 | 2.0 | 2.0 | | | | | | |
| | TPE-Q | | | | | | | 2.4 | 2.4 | 2.4 | | | |
| | TPE-R | | | | | | | | | | 2.4 | 2.4 | 2.4 |
| Additive | 1,2- | 0.1 | 0.2 | 0.4 | 0.1 | 0.2 | 0.4 | 0.1 | 0.2 | 0.4 | 0.1 | 0.2 | 0.4 |
| compound | dimethylimidazole | | | | | | | | | | | | |
| (equivalent/ | 1-methylimidazole | | | | | | | | | | | | |
| repeating | imidazole | | | | | | | | | | | | |
| unit) | | | | | | | | | | | | | |

| | | | | | | | | | | | | |
|---|---|---|---|---|---|---|---|---|---|---|---|---|
| Thickness/μm | 42 | 42 | 50 | 42 | 42 | 52 | 44 | 42 | 42 | 44 | 42 | 40 |
| Tensile modulus of elasticity/GPa | 5.3 | 6.0 | 6.3 | 5.3 | 5.9 | 5.7 | 5.8 | 6.0 | 5.8 | 5.9 | 6.1 | 6.0 |
| Elongation at break/% GL | 6 | 15 | 19 | 13 | 19 | 17 | 14 | 18 | 19 | 17 | 21 | 22 |
| Load at break/N | 31.5 | 34.8 | 46.7 | 31.7 | 35.8 | 46.5 | 36.6 | 34.7 | 37.0 | 35.5 | 33.8 | 35.3 |
| CTE@100-250° C./ppm · K⁻¹ | — | — | — | — | — | — | — | — | — | — | — | — |
| Transmittance at 400 nm/% | 86 | 84 | 82 | 86 | 84 | 82 | 85 | 84 | 83 | 85 | 84 | 84 |
| YI | 1.8 | 2.2 | 2.9 | 1.7 | 2.1 | 2.9 | 1.9 | 2.1 | 2.2 | 2.1 | 2.2 | 2.4 |
| Haze/% | 0.4 | 0.4 | 0.2 | 0.2 | 0.2 | 0.3 | 0.3 | 0.1 | 0.2 | 0.3 | 0.2 | 0.2 |
| 5% weight loss temperature/° C. | — | — | — | — | — | — | — | — | — | — | — | — |
| Solvent resistance | ◯ | ◯ | ◯ | ◯ | ◯ | ◯ | ◯ | ◯ | ◯ | ◯ | ◯ | ◯ |

### INDUSTRIAL APPLICABILITY

According to the present invention, there may be provided a polyimide film which has excellent transparency and excellent mechanical properties, specifically a tensile modulus of elasticity and a load at break, and the like; and a polyimide precursor and a polyimide precursor composition from which a polyimide film having excellent transparency and excellent mechanical properties, specifically a tensile modulus of elasticity and a load at break, and the like, may be obtained. The polyimide film of the present invention, and the polyimide film obtained from the polyimide precursor of the present invention have high transparency and excellent mechanical properties such as a tensile modulus of elasticity and a load at break, and also have a low coefficient of linear thermal expansion; therefore the polyimide films may be suitably used, for example, for a cover sheet (protective film) for a display screen, and for a substrate for a display, a touch panel, a solar battery, or the like.

1. A polyimide film consisting essentially of a polyimide comprising a repeating unit represented by the following chemical formula (1) in an amount of 50 mol % or more relative to the total repeating units, or a polyimide comprising a repeating unit represented by the following chemical formula (1) and a repeating unit represented by the following chemical formula (2) in an amount of 50 mol % or more relative to the total repeating units: 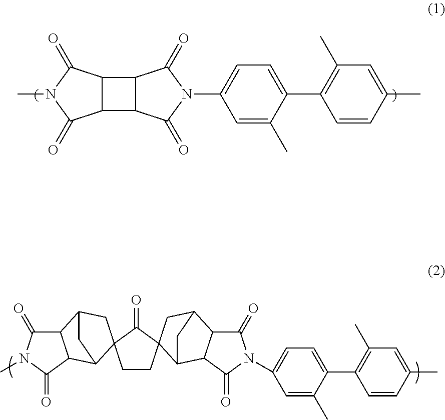
wherein the film has a YI (yellowness index) of 4 or less, a tensile modulus of elasticity of 4 GPa or more, and a load at break of 15 N or more.

2. The polyimide film according to claim 1, wherein the polyimide film has a thickness of 5 μm to 200 μm.

3. The polyimide film according to claim 1, wherein the polyimide comprises a repeating unit represented by the following chemical formula (3) [including a repeating unit represented by the chemical formula (1)] in an amount of 90 mol % or more relative to the total repeating units, or comprises a repeating unit represented by the following chemical formula (3) and a repeating unit represented by the following chemical formula (4) [including a repeating unit represented by the chemical formula (1) and a repeating unit represented by the chemical formula (2)] in an amount of 90 mol % or more relative to the total repeating units: 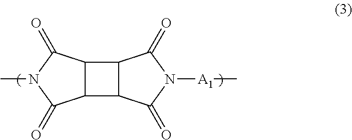
wherein A₁ is a divalent group having an aromatic ring, 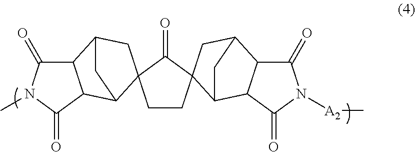
wherein A₂ is a divalent group having an aromatic ring,
and the amount of the repeating unit represented by the chemical formula (1), or the total amount of the repeating unit represented by the chemical formula (1) and the repeating unit represented by the chemical formula (2) is 50 mol % to 100 mol % relative to the total repeating units.

4. The polyimide film according to claim 1, wherein the polyimide film has a haze of 3% or less.

5. A method of producing the polyimide film according to claim 1 comprising imidizing a polyimide precursor composition comprising
a polyimide precursor comprising a repeating unit represented by the following chemical formula (1A) in an amount of 50 mol % or more relative to the total repeating units, or a polyimide precursor comprising a repeating unit represented by the following chemical formula (1A) and a repeating unit represented by the following chemical formula (2A) in an amount of 50 mol % or more relative to the total repeating units: 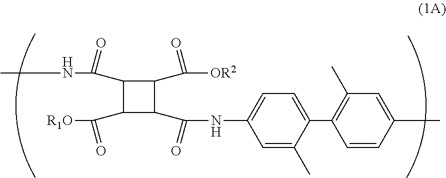
wherein R₁ and R₂ are each independently hydrogen, an alkyl group having 1 to 6 carbon atoms, or an alkylsilyl group having 3 to 9 carbon atoms, 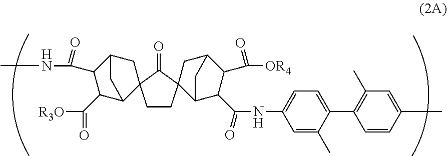
wherein R₃ and R₄ are each independently hydrogen, an alkyl group having 1 to 6 carbon atoms, or an alkylsilyl group having 3 to 9 carbon atoms,
and
an imidazole compound and/or a trialkylamine compound.

6. The method according to claim 5, wherein the polyimide precursor comprises a repeating unit represented by the following chemical formula (3A) [including a repeating unit represented by the chemical formula (1A)] in an amount of 90 mol % or more relative to the total repeating units, or comprises a repeating unit represented by the following chemical formula (3A) and a repeating unit represented by the following chemical formula (4A) [including a repeating unit represented by the chemical formula (1A) and a repeating unit represented by the chemical formula (2A)] in an amount of 90 mol % or more relative to the total repeating units: 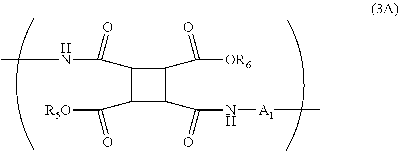
wherein A₁ is a divalent group having an aromatic ring; and R₅ and R₆ are each independently hydrogen, an alkyl group having 1 to 6 carbon atoms, or an alkylsilyl group having 3 to 9 carbon atoms, 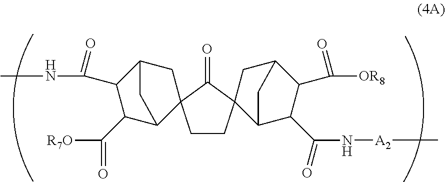
wherein A₂ is a divalent group having an aromatic ring; and R₇ and R₈ are each independently hydrogen, an alkyl group having 1 to 6 carbon atoms, or an alkylsilyl group having 3 to 9 carbon atoms, and
the amount of the repeating unit represented by the chemical formula (1A), or the total amount of the repeating unit represented by the chemical formula (1A) and the repeating unit represented by the chemical formula (2A) is 50 mol % to 100 mol % relative to the total repeating units.

7. The method according to claim 5, wherein the amount of the imidazole compound and/or the trialkylamine compound in the polyimide precursor composition is less than 4 mol relative to 1 mol of the repeating unit of the polyimide precursor.

8. The method according to claim 5, wherein the polyimide precursor composition comprises any one or more of 1,2-dimethylimidazole, 1-methylimidazole or imidazole as the imidazole compound, or comprises triethylamine as the trialkylamine compound.

9. A method for producing the polyimide film according to claim 1, comprising imidizing a polyimide precursor comprising a repeating unit represented by the following chemical formula (1A) and a repeating unit represented by the following chemical formula (2A) in an amount of 50 mol % or more relative to the total repeating units: 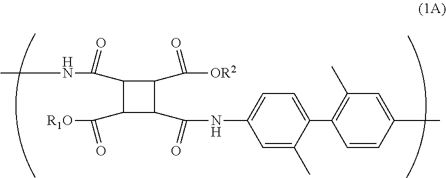
wherein R₁ and R₂ are each independently hydrogen, an alkyl group having 1 to 6 carbon atoms, or an alkylsilyl group having 3 to 9 carbon atoms, 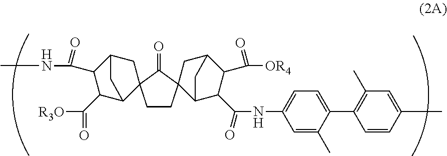
wherein R₃ and R₄ are each independently hydrogen, an alkyl group having 1 to 6 carbon atoms, or an alkylsilyl group having 3 to 9 carbon atoms.

10. The method according to claim 9, wherein the amount of the repeating unit represented by the chemical formula (1A) is 10 mol % to 90 mol % relative to the total repeating units, and the amount of the repeating unit represented by the chemical formula (2A) is 10 mol % to 90 mol % relative to the total repeating units.

11. The method according to claim 9, wherein the polyimide precursor comprises a repeating unit represented by the following chemical formula (3A) and a repeating unit represented by the following chemical formula (4A) [including a repeating unit represented by the chemical formula (1A) and a repeating unit represented by the chemical formula (2A)] in an amount of 90 mol % or more relative to the total repeating units: 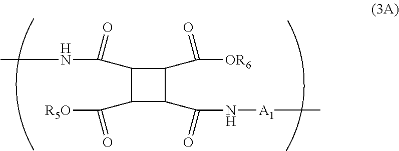
wherein A₁ is a divalent group having an aromatic ring; and R₅ and R₆ are each independently hydrogen, an alkyl group having 1 to 6 carbon atoms, or an alkylsilyl group having 3 to 9 carbon atoms, 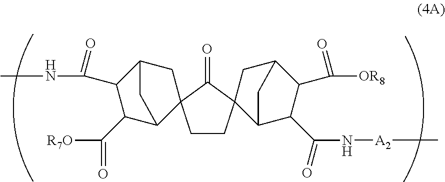
wherein A₂ is a divalent group having an aromatic ring; and R₇ and R₈ are each independently hydrogen, an alkyl group having 1 to 6 carbon atoms, or an alkylsilyl group having 3 to 9 carbon atoms, and
the total amount of the repeating unit represented by the chemical formula (1A) and the repeating unit represented by the chemical formula (2A) is 50 mol % to 100 mol % relative to the total repeating units.

12. (canceled)

13. The polyimide film according to claim 1,
wherein the polyimide is obtained by heating a polyimide precursor composition comprising a precursor of the polyimide, and an imidazole compound and/or a trialkylamine compound.

14. (canceled)

15. The polyimide film according to claim 1, wherein the polyimide is a polyimide comprising a repeating unit represented by the chemical formula (1) and a repeating unit represented by the chemical formula (2) in an amount of 50 mol % or more relative to the total repeating units.

16.-18. (canceled)

19. A cover sheet for a display screen, comprising the polyimide film according to claim 1.

20. A substrate for a display, a touch panel or a solar battery, comprising the polyimide film according to claim 1.
